(19) United States
(12) Patent Application Publication
(10) Pub. No.: US 2026/0125615 A1
(43) Pub. Date: May 7, 2026

(54) ENZYMATIC CAUSTIC FREE DETERGENT COMPOSITIONS FOR CLEANING DAIRY PROCESSING SYSTEMS

(71) Applicant: ECOLAB USA INC., Saint Paul, MN (US)

(72) Inventors: Jesse Ray Murphy, Apple Valley, MN (US); Jack Lehman, Saint Paul, MN (US); Temilola Famakinwa, Greensboro, NC (US); Jack Matuska, Richfield, MN (US); Noah Holzer, Burnsville, MN (US); Christine Fehlis, Langenfeld (DE); Krista Otting, Bloomington, MN (US); Aure-Anne Masdupuy, Saint Paul (DE)

(21) Appl. No.: 19/382,530

(22) Filed: Nov. 7, 2025

Related U.S. Application Data
(60) Provisional application No. 63/717,521, filed on Nov. 7, 2024.

(51) Int. Cl. C11D 1/825; C11D 1/66; C11D 1/72; C11D 1/76; C11D 3/20; C11D 3/30; C11D 3/34; C11D 3/37; C11D 3/386

(52) U.S. Cl. CPC C11D 1/8255; C11D 3/2065; C11D 3/30; C11D 3/3454; C11D 3/3765; C11D 3/38618; C11D 1/662; C11D 1/72; C11D 1/76

(57) ABSTRACT

The disclosure relates to enzymatic caustic-free detergent compositions for cleaning dairy processing surfaces (such as dairy CIP and dairy COP systems and their components). Also disclosed are methods of making and using the detergent compositions to beneficially remove fouling and clean the surfaces utilized in dairy production. The enzymatic caustic-free detergent compositions preferably comprise an enzyme, a surfactant, a water conditioning agent, a C2-C10 polyol, a buffer system, a salt, and water.

### CROSS-REFERENCE TO RELATED APPLICATION

This application claims priority under 35 U.S.C. § 119 to Provisional Application U.S. Ser. No. 63/717,521, filed on Nov. 7, 2024, which is herein incorporated by reference in its entirety including without limitation, the specification, claims, and abstract, as well as any figures, tables, or examples thereof.

### TECHNICAL FIELD

The present disclosure relates generally to the field of dairy processing cleaning. In particular, to enzymatic caustic free detergent compositions and methods of making and using the same to beneficially remove fouling and clean the surfaces utilized in dairy production.

### BACKGROUND

A critical challenge in dairy production is fat fouling. Fat and protein soils are difficult to clean using a standard cleaned-in-place regime. Periodic cleaning and sanitizing in the food process industry is a regimen mandated by law and rigorously practiced maintaining exceptionally high standards of food hygiene and shelf-life expected by today's consumer. Residual food soil, left on food contact equipment surfaces for prolonged periods, can harbor and nourish growth of opportunistic pathogen and food spoilage microorganisms that can contaminate foodstuffs processed in close proximity to the residual soil. Ensuring protection of the consumer against potential health hazards associated with food borne pathogens and toxins and maintaining the flavor, nutritional value and quality of the foodstuff requires diligent cleaning and soil removal from any surfaces of which contact the food product directly or are associated with the processing environment.

The cleaning of food preparation surfaces and equipment refers to the treatment given all food product contact surfaces following each period of operation to substantially remove food soil residues including any residue that can harbor or nourish any harmful microorganism. Freedom from such residues, however, does not indicate perfectly clean equipment. Large populations of microorganisms may exist on food process surfaces even after visually successful cleaning. The concept of cleanliness as applied in the food process plant is a continuum wherein absolute cleanliness is the ideal goal always strived for; but, in practice, the cleanliness achieved is of lesser degree.

The technology of cleaning in the food process industry has traditionally been empirical. The need for cleaning treatments existed before a fundamental understanding of soil deposition and removal mechanism was developed. Because of food quality and public health pressures, the food processing industry has attained a high standard of practical cleanliness and sanitation. This has not been achieved without great expense, and there is considerable interest in more efficient and less costly technology. As knowledge about soils, the function of cleaning chemicals, and the effects of cleaning procedures increased and, as improvements in plant design and food processing equipment became evident, the cost effectiveness and capability of cleaning treatments, i.e. cleaning products and procedures, to remove final traces of residue have methodically improved. The consequence for the food process industry and for the public is progressively higher standards of cleanliness and quality.

Food processing industries regularly use cleaning-in-place (CIP) clean-up procedures and automation. CIP systems are generally found in industries which produce fluidized ingestible products for humans or animals such as the dairy industry, the pharmaceutical industry, and the food industry. CIP systems are generally regarded as large production plant systems having reservoirs, pipes, pumps and mixing vessels which cannot be broken down to be cleaned. Additionally, CIP preparation systems often require high sanitization when used in the production of ingestible substances. Generally, CIP systems utilize caustic cleaning compositions and monitor the amounts of the compositions via conductivity. In addition to CIP systems, food processing clean-out-of-place (COP) systems and heat exchangers are widely used in certain industries and require similar cleaning procedures and encounter similar difficulties.

Dairy CIP and dairy COP can benefit from enzymatic caustic free cleaning compositions that replace traditional caustic compositions. It is therefore a goal of this disclosure to provide enzymatic caustic free products which can improve cleaning and hygiene in dairy processing systems. It is a further objective of the compositions and methods described herein to provide rinse savings and provide effluent benefits such as a reduction in sodium content.

Other objects, advantages and features of the present invention will become apparent from the following specification taken in conjunction with the accompanying drawings.

### BRIEF SUMMARY OF PREFERRED EMBODIMENTS

Disclosed herein are methods of cleaning dairy processing systems and equipment, including dairy CIP systems and/or dairy COP systems. These methods provide various advantages over existing dairy membrane cleaning methodologies. For example, the compositions provide caustic free enzymatic cleaning compositions for cleaning dairy processing systems as well as methods of cleaning dairy processing systems. Beneficially, the compositions and methods, while without the use of caustic alkalinity, provide robust cleaning of difficult dairy processing soils, reduce the rinsing required (thereby saving water), and offer improvements in the effluent, including but not limited to a reduction in sodium content in the effluent. Other advantages and benefits of the disclosed methods are described herein.

It is a primary object, feature, and/or advantage of the present disclosure to improve on or overcome the deficiencies in the art.

A preferred embodiment comprises a method of cleaning a dairy CIP system comprising circulating a first dose of a cleaning composition to the dairy CIP system; wherein the cleaning composition comprises a serine protease enzyme; a surfactant comprising an alkylpolyglucoside, an EO-PO block copolymer, an alcohol alkoxylate, and/or mixtures thereof; a water conditioning agent comprising an aminocarboxylic acid, acrylic acid, polycarboxylic acids, salts of the foregoing, and/or mixtures thereof; a C2-C10 polyol; a buffer system; and water; wherein the pH of the cleaning composition is between about 6 and about 11; monitoring the cleaning composition during the cleaning of the dairy processing system; adjusting the concentration of the cleaning composition by adding additional water and/or an additional dose of the cleaning composition to the dairy processing system.

A preferred embodiment comprises a caustic free liquid cleaning composition for dairy processing systems and components thereof comprising: a serine protease enzyme; from about 0.5 to about 20% actives of a surfactant comprising an alkylpolyglucoside, an EO-PO block copolymer, an alcohol alkoxylate, and/or a mixture thereof; from about 0.1 to about 10% actives of a water conditioning agent; wherein the water conditioning agent comprises an aminocarboxylic acid, acrylic acid, polyacrylic acid, and/or a mixture thereof; a C2-C10 polyol; a buffer system comprising an acid and/or a base; and water; wherein the composition has a pH of from about 6 to about 11.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

While multiple embodiments are disclosed, still other embodiments of the present invention will become apparent to those skilled in the art from the following detailed description, which shows and describes illustrative embodiments of the invention.

Accordingly, the figures and detailed description are to be regarded as illustrative in nature and not restrictive.

### BRIEF DESCRIPTION OF THE FIGURES

FIG. 1 is a graph showing the change in delta L, or cleaning efficacy, of enzyme and buffer systems compared to an alkaline inline formula from 5 to 40 minutes.

FIG. 2 is a graph showing the percent removal of cheese on melamine tiles by Formula A and an alkaline inline formula at 55° C., 65° C., and 72° C.

FIG. 3 is a graph showing the percent removal of cheese on melamine tiles by Formula A at 0.05%, 0.10%, 0.15%, and 0.15% at 65° C.

FIG. 4 is a picture showing the cleaning performance of enzymatic composition Formula A.

FIG. 5 is a picture showing the cleaning performance of an alkaline control formula.

FIG. 6 is a graph showing the predicted enzyme stability over a year at various temperatures.

FIG. 7 is a graph showing the measured enzyme stability over a year at ambient temperature.

FIG. 8 is a graph showing the enzyme stability of formulas with various active percent amounts of MGDA and the percent stability of the enzyme relative to a control.

FIG. 9 is graphs showing the biomass compatibility of Formula G in Phases 2-4 of testing.

FIGS. 10A-C are graphs showing the validation of rinsewater being free of residual enzyme after the rinse step is completed, where the baseline formula was a traditional a chlorinated alkaline detergent.

FIG. 11 is a graph of the 3DT Water Savings comparing the rinsewater savings of the baseline formula and Formula H.

FIG. 12 is a graph showing the flow rate by test phase of a baseline formulation, and Formulas C, D, and E in Field Test B.

FIG. 13 is a graph of the first cleaning with baseline product after 3 months trial of enzymatic cleaning in Field Test C.

FIG. 14 is a graph of surfactant blend performance on the Butterfat Cleaning Test.

FIG. 15 is a graph showing the ability of the enzymatic Formula A to remove protein as compared to a built alkaline cleaner testing the cleaners against baked-on cheese on melamine tiles.

FIG. 16 is a graph showing the ability of the enzymatic Formulas A-C to remove high-milkfat soils was tested against a built alkaline cleaner using the Butterfat Cleaning Test.

FIG. 17 is a graph showing the ability of the enzymatic Formulas C and D against a built chlorinated alkaline cleaner to clean cold-process dairy soils.

FIG. 18 is a graph showing the ability of the enzymatic Formulas B, C, and E against a built alkaline cleaner to clean hot-process dairy soils.

FIG. 19 is a graph showing the cleaning performance of an alkaline+hypochlorite baseline as compared to Formula C in the CIP process of Field Test A.

FIG. 20 is a graph showing the visual inspection results over time of an alkaline+hypochlorite baseline as compared to Formula C in the CIP process of Field Test A.

FIG. 21 is a graph showing the raw receiving visual inspection results of a chlorinated-alkaline baseline composition and Formula D in Field Test C.

FIG. 22 is a graph showing the cold-processing visual inspection results of a chlorinated-alkaline baseline composition and Formula D in Field Test C.

FIG. 23 is a graph showing the pasteurizer, end of wash pressure differential results of an alkaline baseline composition and Formula D+Formula E in Field Test C.

FIG. 24 is a graph showing the pasteurizer, end of wash flow rate results of an alkaline baseline composition and Formula D+Formula E in Field Test C.

FIG. 25 shows graphs of modeled enzyme activity over one year of Formula A and several variations of Formula A.

FIG. 26 is a graph showing the enzyme stability in model CIP skid utilizing Formula A.

FIG. 27 is a graph showing the product concentration re-use results of a chlorine titration, alkaline titration, and enzyme activity assay in Field Test A.

FIG. 28 is a graph showing the product concentration re-use results of CIP systems 1-3 in Field Test C.

FIG. 29 is a graph showing the in-use foam height of Formula A and various defoamers showing the ability of various surfactants to form foam.

FIG. 30 is a graph showing the product concentration over CIP in Field Test B, demonstrating the compatibility of the enzymatic cleaner with the existing CIP dosing control system.

FIG. 31 is a graph of the conductivity read by the CIP control unit for one wash step in each phase of Field Test D.

Various embodiments of the enzymatic detergent compositions, methods of use, and methods of manufacture are described herein. Reference to various embodiments does not limit the scope of the invention. Figures represented herein are not limitations to the various embodiments according to the invention and are presented for exemplary illustration of the invention.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The embodiments of this invention are not limited to particular dairy CIP and COP systems and devices which can vary by manufacturer and facility needs, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in their SI accepted forms.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

References to elements herein are intended to encompass any or all of their oxidative states and isotopes.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “percent active” refers to the active concentration of an ingredient as the weight of that substance divided by the total weight of the composition and multiplied by 100. This can differ from weight percent where a raw ingredient is not in 100% active form. The term “ppm active” refers to the active concentration of an ingredient in parts per million of the total weight of the composition. The term “ppb active” refers to the active concentration of an ingredient in parts per billion of the total weight of the composition.

The methods and compositions described herein may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Enzymatic Detergent Compositions

Described herein are the ingredients and methods of making and using enzymatic detergent compositions. In a preferred embodiment, the enzymatic detergent compositions are liquid. A preferred embodiment of the enzymatic detergent compositions are useful for cleaning dairy CIP systems and/or dairy COP systems. In some embodiments, the enzymatic detergent compositions can be used for cleaning other surfaces, such as CIP systems, COP systems, and/or in COP tanks.

The enzymatic detergent compositions comprise a serine protease enzyme, a surfactant, a water conditioning agent, a C2-C10 polyol, a buffer system, and water. Preferably the surfactant comprises an alkylpolyglucoside, an alkoxylated alcohol, an EO-PO block copolymer, and/or a mixture thereof. Preferably the water conditioning agent comprises an aminocarboxylic acid, acrylic acid, polyacrylic acid, and/or a mixture thereof. Various additional ingredients can be added to the enzymatic detergent compositions including an optional coupler. Preferred compositions for cleaning dairy processing systems are described in Tables 1A-1C below. Table 1A provides preferred ranges for an enzymatic detergent composition where the optional coupling agent is not included. Table 1B provides preferred ranges for an enzymatic detergent composition where the optional coupling agent is included. Table 1C provides preferred ranges for a use solution composition.

TABLE 1A
Exemplary Enzymatic Detergent Compositions (% actives)

| | | More | More | Most |
|---|---|---|---|---|
| | Preferred | Preferred | Preferred | Preferred |
| | Formulation | Formulation | Formulation | Formulation |
| Protease | 0.01-1 | 0.01-0.5 | 0.05-0.5 | 0.05-0.35 |
| Enzyme | | | | |
| Surfactant | 0.5-20 | 1-20 | 1-15 | 2.5-7.5 |
| Water | 0.1-10 | 0.1-8 | 0.1-5 | 0.5-1 |
| Conditioning | | | | |
| Agent | | | | |
| Polyol | 0.01-60 | 0.1-60 | 1-45 | 5-30 |
| Buffer | 0.1-25 | 0.1-20 | 0.5-20 | 1-15 |
| Water | 20-80 | 20-75 | 20-70 | 25-65 |
| Optional | 0-25 | 0.01-25 | 0.01-20 | 0.1-20 |
| ingredients | | | | |

TABLE 1B
Exemplary Enzymatic Dairy CIP Detergent
Compositions (% actives)

| | | More | More | Most |
|---|---|---|---|---|
| | Preferred | Preferred | Preferred | Preferred |
| | Formulation | Formulation | Formulation | Formulation |
| Protease | 0.01-1 | 0.01-0.5 | 0.05-0.5 | 0.05-0.35 |
| Enzyme | | | | |
| Surfactant | 0.5-20 | 1-20 | 1-15 | 2.5-7.5 |
| Water | 0.1-10 | 0.1-8 | 0.1-5 | 0.5-1 |
| Conditioning | | | | |
| Agent | | | | |
| Polyol | 0.01-60 | 0.01-60 | 1-45 | 5-30 |
| Coupling | 0.1-10 | 0.1-5 | 0.5-5 | 1-5 |
| Agent | | | | |
| Buffer | 0.1-25 | 0.1-20 | 0.5-20 | 1-15 |
| Water | 20-80 | 20-75 | 20-70 | 25-65 |
| Optional | 0-25 | 0.01-25 | 0.01-20 | 0.1-20 |
| ingredients | | | | |

TABLE 1C
Exemplary Use Solution Compositions (ppm actives)

| | | More | More | Most |
|---|---|---|---|---|
| | Preferred | Preferred | Preferred | Preferred |
| | Formulation | Formulation | Formulation | Formulation |
| Protease | 0.05-200 | 0.1-175 | 0.5-150 | 1-100 |
| Enzyme | | | | |
| Surfactant | 0.25-4000 | 1-2000 | 10-1500 | 50-750 |
| Water | 0.5-2000 | 1-1000 | 5-500 | 10-100 |
| Conditioning | | | | |
| Agent | | | | |
| Polyol | 0.05-12,000 | 1-6000 | 25-4500 | 100-3000 |
| Optional | 0-2000 | 1-1000 | 5-750 | 20-500 |
| Coupling | | | | |
| Agent | | | | |
| Buffer | 0.5-5000 | 1-3000 | 5-2000 | 20-1500 |
| Water | Q.S. | Q.S. | Q.S. | Q.S. |
| Optional | 0-5000 | 0.5-4000 | 1-3000 | 2-2000 |
| ingredients | | | | |

Preferably, the compositions are liquid. The liquid compositions can be prepared as concentrated liquid compositions, diluted ready to use compositions, a gel, or a combination thereof.

Preferably, the enzymatic detergent compositions have a near neutral pH to moderately alkaline pH. For example, embodiments of the detergent compositions will provide a pH of between about 6 and about 11. In a preferred embodiment, the enzymatic detergents will provide a pH between about 6 and about 11, preferably between about 7 and about 10.5, most preferably between about 8 and about 10.

A primary consideration for dairy CIP cleaners is the ability to track the chemical concentration live in the CIP system. This is currently done with alkaline and chlorinated-alkaline CIP cleaners, in which the electrical conductivity of the solution is measured as an analog to the chemical concentration. This is particularly beneficial in two scenarios: dosing and phase separation. In dosing, the conductivity of the use-dilution cleaner can be measured continuously and fed into an automated dosing system, which will continue to pump concentrated cleaner into the CIP tank until a set conductivity threshold is reached. In this way, a dependable concentration of cleaner can always be maintained in the CIP tank. In re-use systems, phase separation is a critical step in the post-wash rinse which determines when the wash solution has all been successfully reclaimed. This is generally done using an inline conductivity measurement on the CIP return line, allowing an automated system to see when the chemical concentration has dropped below a set threshold so that the wash solution can be reclaimed and the rinse solution can be diverted to the drain. As alkaline detergents by their nature contain a substantial amount of basic salts, they are highly conductive; however, enzymatic detergents generally have much lower conductivity. As most dairy CIP systems are configured to control dosing and phase separation though conductivity readings, it is highly preferred that a re-use enzymatic detergent would also be able to be controlled based on its conductivity.

### Protease Enzyme

The enzymatic detergent compositions comprise a protease enzyme. In a preferred embodiment, the enzymatic detergent compositions comprise a serine protease enzyme. Any protease or mixture of proteases, from any source, can be used in the enzymatic detergent compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, Liquanase®, and Progress™ (also sold under the name Everis™) each available from Novonesis, Lavergy® available from BASF, and Optimase®, available from IFF.

The protease enzyme is preferably in an amount between about 0.01 and about 1% actives, between about 0.01 and about 0.5% actives, more preferably between about 0.05 and about 0.5% actives, most preferably between about 0.05 and about 0.35% actives. In use solution the protease enzyme is preferably in an amount between about 0.05 and about 200 ppm actives, between about 0.1 and about 175 ppm actives, more preferably between about 0.5 and about 150 ppm actives, most preferably between about 1 and about 100 ppm actives.

Some enzymes compositions include an enzyme stabilizer which is present in a minor amount. Enzyme stabilizers often act as competitive inhibitors. If an enzyme stabilizer is not included in the enzyme product, then one can optionally be added in a minor amount. Concentration of enzyme stabilizers can be determined by those skilled in the art; a preferred amount can be between about 0.01% active and about 0.1% active.

### Surfactant

The enzymatic detergent compositions comprise a surfactant. Preferred surfactants include, but are not limited to, nonionic surfactants. Most preferably, the surfactant comprises an alkylpolyglucoside, an alcohol alkoxylate, an EO-PO block copolymer, and/or mixtures thereof.

Preferably, the enzymatic detergent compositions comprise surfactant in an amount between about 0.5 and about 20% actives, more preferably between about 1 and about 20% actives, more preferably between about 1 and about 15% actives, and most preferably between about 2.5 and about 7.5% actives. In use solution the surfactant is preferably in an amount between about 0.25 and about 4000 ppm actives, more preferably between about 1 and about 2000 ppm actives, more preferably between about 10 and about 1500 ppm actives, and most preferably between about 50 and about 750 ppm actives.

Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with C₁-C₅alkylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties.

Suitable nonionic surfactants include the following:

1. Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp. Such compounds can include, by way of example, an EO/PO capped alkoxylated glycerol, wherein the EO groups are less than about 50%, less than about 40%, and preferably less than about 30% of the surfactant. Pluronic® compounds are difunctional (two reactive hydrogens). Tetronic® compounds are tetra-functional block copolymers.

2. Condensation products of one mole of alkyl phenol wherein the alkyl chain, of straight chain or branched chain configuration, or of single or dual alkyl constituent, contains from 8 to 18 carbon atoms with from 3 to 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

3. Condensation products of one mole of a saturated or unsaturated, straight or branched chain alcohol having from 6 to 24 carbon atoms with from 3 to 50 moles of C₁-C₅ alkylene oxide. The alcohol moiety can consist of mixtures of alcohols in the above delineated carbon range or it can consist of an alcohol having a specific number of carbon atoms within this range. Examples of like commercial surfactants are available under the trade names Neodol® manufactured by Shell Chemical Co. and Alfonic® manufactured by Vista Chemical Co.

4. Condensation products of one mole of saturated or unsaturated, straight or branched chain carboxylic acid having from 8 to 18 carbon atoms with from 6 to 50 moles of C₁-C₅ alkylene oxide. The acid moiety can consist of mixtures of acids in the above defined carbon atom range or it can consist of an acid having a specific number of carbon atoms within the range. Examples of commercial compounds of this chemistry are available on the market under the trade names Nopalcol® manufactured by Henkel Corporation and Lipopeg® manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols can be used. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions containing amylase and/or lipase enzymes because of potential incompatibility.

Examples of nonionic low foaming surfactants include:

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. These reverse Pluronics® are manufactured by BASF Corporation under the trade name Pluronic® R surfactants. Likewise, the Tetronic® R surfactants are produced by BASF Corporation by the sequential addition of ethylene oxide and propylene oxide to ethylenediamine.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

7. The alkylphenoxypolyethoxyalkanols of U.S. Pat. No. 2,903,486 issued Sep. 8, 1959 to Brown et al. and represented by the formula

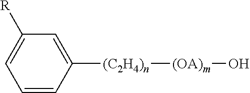

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘ H wherein Y is the residue of organic compound having from 1 to 6 carbon atoms and one reactive hydrogen atom, n has an average value of at least 6.4, as determined by hydroxyl number and m has a value such that the oxyethylene portion constitutes 10% to 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from 2 to 6 carbon atoms and containing x reactive hydrogen atoms in which x has a value of at least 2, n has a value such that the molecular weight of the polyoxypropylene hydrophobic base is at least 900 and m has value such that the oxyethylene content of the molecule is from 10% to 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional useful conjugated polyoxyalkylene surface-active agents correspond to the formula: P[(C₃H₆O)ₙ(C₂H₄O)ₘH]ₓ wherein P is the residue of an organic compound having from 8 to 18 carbon atoms and containing x reactive hydrogen atoms in which x has a value of 1 or 2, n has a value such that the molecular weight of the polyoxyethylene portion is at least 44 and m has a value such that the oxypropylene content of the molecule is from 10% to 90% by weight. In either case the oxypropylene chains may contain optionally, but advantageously, small amounts of ethylene oxide and the oxyethylene chains may contain also optionally, but advantageously, small amounts of propylene oxide.

8. Polyhydroxy fatty acid amide surfactants include those having the structural formula R₂CONR₁Z in which: R₁ is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction, such as a glycityl moiety.

9. The alkyl ethoxylate condensation products of aliphatic alcohols with from 0 to 25 moles of ethylene oxide are suitable. The alkyl chain of the aliphatic alcohol can either be straight or branched, primary or secondary, and generally contains from 6 to 22 carbon atoms.

10. The ethoxylated C₆-C₁₈ fatty alcohols and C₆-C₁₈ mixed ethoxylated and propoxylated fatty alcohols are suitable surfactants, particularly those that are water soluble. Suitable ethoxylated fatty alcohols include the C₁₀-C₁₈ ethoxylated fatty alcohols with a degree of ethoxylation of from 3 to 50.

11. Further exemplary nonionic surfactants suitable for the compositions can include alkyl polyglucosides. Alkyl polyglucosides are a type of alkyl polyglycoside derived from a glucose-based polymer. An alkyl polyglucoside, as used herein in this disclosure, is a molecule having one to ten glucose units backbone and at least one alkyl group attached one of the OH groups and has a generic structure of

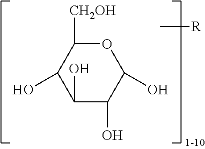

wherein R is an alkyl group and can be attached to any or all of the OH group in the molecule. A cationic alkyl polyglucoside, as used herein in this disclosure, is an alkyl polyglucoside having at least one cationic group in its alkyl group(s).

Preferably, the alkyl group has a carbon chain length between about 1 and about 20 carbons, between about 8 and about 20 carbons, between about 10 and about 18 carbons, between about 10 and about 16 carbons, and preferably between about 12 and about 16 carbons.

12. Fatty acid amide surfactants include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

13. Nonionic surfactants also include the class defined as alkoxylated amines or, most particularly, alcohol alkoxylated/aminated/alkoxylated surfactants. These nonionic surfactants may be at least in part represented by the general formulae:

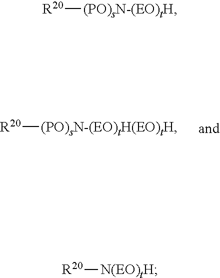

in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, and t is 1-10, preferably 2-5. Other variations on the scope of these compounds may be represented by the alternative formula:

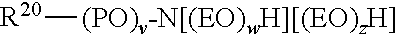

in which R²⁰ is as defined above, v is 1 to 20 (e.g., 1, 2, 3, or 4 (preferably 2)), and w and z are independently 1-10, preferably 2-5.

14. Reverse polyoxyalkylene block copolymer(s) (also known as alkoxylated block copolymer(s)). The reverse polyoxyalkylene block copolymers, especially -(EO)ₑ-(PO)ₚ block copolymers, are effective in preventing or minimizing any normal foaming activity of other components. Because of their better water-solubility characteristics, the reverse polyoxyethylene-polyoxypropylene (i.e., reverse -(EO)ₑ—(PO)ₚ) block copolymers are preferred over other reverse polyoxyalkylene block copolymers, such as those that contain polyoxybutylene blocks.

The polyoxyalkylene block copolymers useful in the present compositions can be formed by reacting alkylene oxides with initiators. Preferably, the initiator is multifunctional because of its use results in “multibranch” or “multiarm” block copolymers. For example, propylene glycol (bifunctional), triethanol amine (trifunctional), and ethylenediamine (tetrafunctional) can be used as initiators to initiate polymerization of ethylene oxide and propylene oxide to produce reverse block copolymers with two branches (i.e., arms or linear units of polyoxyalkylenes), three branches, and four branches, respectively. Such initiators may contain carbon, nitrogen, or other atoms to which arms or branches, such as blocks of polyoxyethylene (EO)ₑ, polyoxypropylene (PO)ₚ, polyoxybutylene (BO)_{b}, -(EO)ₑ—(PO)ₚ, -(EO)ₑ—(BO)_{b}, or -(EO)₃—(PO)ₚ—(BO)_{b}, can be attached. Preferably, the reverse block copolymer has arms or chains of polyoxyalkylenes that are attached to the residues of the initiators contain end blocks of -(EO)ₓ—(PO)_{y}, which have ends of polyoxypropylene (i.e., —(PO)_{y}), wherein x is about 1 to 1000 and y is about 1 to 500, more preferably x is about 5 to 20 and y is about 5 to 20.

The reverse block copolymer can be a straight chain, such as a three-block copolymer,

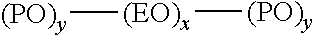

wherein x is about 1 to 1000, preferably about 4 to 230; and y is about 1 to 500, preferably about 8 to 27. Such a copolymer can be prepared by using propylene glycol as an initiator and adding ethylene oxide and propylene oxide. The polyoxyalkylene blocks are added to both ends of the initiator to result in the block copolymer. In such a linear block copolymer, generally the central (EO)ₓ contains the residue of the initiator and x represents the total number of EO on both sides of the initiator. Generally, the residue of the initiator is not shown in a formula such as the three-block copolymer above because it is insignificant in size and in contribution to the property of the molecule compared to the polyoxyalkylene blocks. Likewise, although the end block of the polyoxyalkylene block copolymer terminates in a —OH group, the end block is represented by —(PO)ₚ, -(EO)ₓ, —(PO)_{y}, and the like, without specifically showing the —OH at the end. Also, x, y, and z are statistical values representing the average number of monomer units in the blocks.

The reverse polyoxyalkylene block copolymer can have more than three blocks, an example of which is a five-block copolymer,

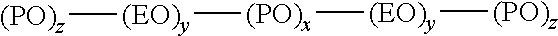

wherein x is about 1 to 1,000, preferably about 7 to 21; y is about 1 to 500, preferably about 10 to 20; and z is about 1 to 500, preferably about 5 to 20.

A chain of blocks may have an odd or even number of blocks. Also, in other embodiments, copolymers with more blocks, such as, six, seven, eight, and nine blocks, etc., may be used as long as the end polyoxyalkylene block is either (PO)ₚ or (BO)_{b}. As previously stated, the reverse -(EO)ₑ—(PO)ₚ block copolymer can also have a branched structure having a trifunctional moiety T, which can be the residue of an initiator. The block copolymer is represented by the formula:

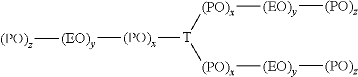

wherein x is about 0 to 500, preferably about 0 to 10; y is about 1 to 500, preferably about 5 to 12, and z is about 1 to 500, preferably about 5 to 10.

Preferred nonionic surfactants include, but are not limited to, reverse Pluronic surfactant having (PO)(EO)(PO) structure and an average molecular weight of less than 3000 g/mole, more preferably less than 2800 g/mole, still more preferably less than 2500 g/mole, wherein the cloud point of a 1% aqueous solution of the surfactant is greater than 30° C., more preferably greater than 35° C., still more preferably greater than 40° C., and most preferably greater than 45° C.

### 15. Branched Alcohol Alkoxylates

Branched alcohol alkoxylate nonionic surfactants are also suitable for the compositions disclosed herein. Preferred branched alcohol alkoxylates include, but are not limited to, Guerbet alcohol alkoxylates having alkoxylation of:

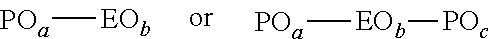

wherein a is between about 1 and about 10; wherein b is between about 1 and about 14; and
wherein c is between about 1 and about 20; and wherein the branched alkyl group has between about 6 and about 20 carbons, more preferably between about 6 and about 18, most preferably between about 8 and about 16.

### Water Conditioning Agent

The enzymatic detergent compositions comprise a water conditioning agent. The water conditioning agent comprises an aminocarboxylic acid, a carboxylic acid, a polycarboxylic acid polymer, and/or a mixture thereof.

Exemplary aminocarboxylic acids include, for example, NTA, N-hydroxyethylaminodiacetic acid, ethylenediaminetetraacetic acid (EDTA), methylglycinediacetic acid (MGDA), hydroxyethylenediaminetetraacetic acid, diethylenetriaminepentaacetic acid, N-hydroxyethyl-ethylenediaminetriacetic acid (HEDTA), glutamic acid N,N-diacetic acid (GLDA), diethylenetriaminepentaacetic acid (DTPA), Iminodisuccinic acid (IDS), ethylenediamine disuccinic acid (EDDS), 3-hydroxy-2,2-iminodisuccinic acid (HIDS), hydroxyethyliminodiacetic acid (HEIDA) and other similar acids having an amino group with a carboxylic acid substituent.

Exemplary carboxylic acids include, for example, short chain, medium chain, and long chain carboxylic acids. Preferred carboxylic acids include C1-C10 short chain carboxylic acids including but not limited to, formic acid, acetic acid, citric acid, tartaric acid, propionic acid, butanoic acid, pentanoic acid, hexanoic acid, heptanoic acid, octanoic acid, nonanoic acid, decanoic acid, lactic acid, maleic acid, oxalic acid, malonic acid, succinic acid, glutaric acid, adipic acid, pimelic acid, and suberic acid.

Polycarboxylic acid polymers may include, but are not limited to those having pendant carboxylate (—CO2-) groups such as acrylic acid homopolymers, maleic acid homopolymers, maleic/olefin copolymers, maleic acid terpolymers, sulfonated copolymers or terpolymers, acrylic/maleic copolymers or terpolymers, methacrylic acid homopolymers, methacrylic acid copolymers or terpolymers, acrylic acid-methacrylic acid copolymers, hydrolyzed polyacrylamides, hydrolyzed polymethacrylamides, hydrolyzed polyamide-methacrylamide copolymers, hydrolyzed polyacrylonitriles, hydrolyzed polymethacrylonitriles, hydrolyzed acrylonitrile-methacrylonitrile copolymers and combinations thereof. Preferred polycarboxylic acids or salts thereof include polyacrylic acid homopolymers, polyacrylic acid copolymers, and maleic acid copolymers and maleic acid terpolymers.

The water conditioning agent is preferably in an amount between about 0.1 and about 10% actives; more preferably between about 0.1 and about 8% actives, more preferably between about 0.1 and about 5% actives, and most preferably between about 0.5 and 1% actives. In use solution, the water conditioning agent is preferably in an amount between about 0.5 and about 2000 ppm actives; more preferably between about 1 and about 1000 ppm actives, more preferably between about 5 and about 500 ppm actives, and most preferably between about 10 and 100 ppm actives.

### Polyol

The enzymatic detergent compositions comprise a polyol. Preferred polyols include, but are not limited to, C2-C10 polyols, more preferably C3-C8 polyols, most preferably C3-C6 polyols. Preferred polyols include, but are not limited to, erythritol, ethylene glycol, galactitol, glycerin, inositol, mannitol, propylene glycol, sorbitol, and mixtures thereof. We have found that some of the polyols, including, but not limited to propylene glycol can benefit the phase stability of the compositions. Thus, in some embodiments, it is preferable to include multiple polyols-one or more to provide enzyme stability and one or more to provide phase stability for the composition. Most preferred polyols for enzyme stability comprise glycerin, sorbitol, and mixtures thereof. In a most preferred embodiment, the enzymatic detergent compositions comprise a mixture of glycerin, propylene glycol, and sorbitol.

In a preferred embodiment of an enzymatic detergent composition, the polyol is preferably in an amount between about 0.01 and about 60% actives, more preferably between about 0.1 and about 60% actives, more preferably between about 1 and about 45% actives, and most preferably between about 5 and about 30% actives. In use solution, the polyol is preferably in an amount between about 0.05 and about 12,000 ppm actives, more preferably between about 1 and about 6000 ppm actives, more preferably between about 25 and about 4500 ppm actives, and most preferably between about 100 and about 3000 ppm actives.

### Coupling Agent

The enzymatic detergent compositions optionally comprise at least one coupling agent. In a preferred embodiment, the enzymatic detergent compositions comprise at least one coupling agent.

Preferred coupling agents include, but are not limited to, a short-chain alkylbenzene sulfonate, alkyl naphthalene sulfonate, and mixtures thereof. Preferred short-chain alkylbenzene sulfonate and/or alkyl naphthalene sulfonate include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, or sodium butyl naphthalene, a mixture thereof.

In a preferred embodiment of an enzymatic detergent composition, the coupling agent is preferably in an amount between about 0.1 and about 10% actives, more preferably between about 0.1 and about 5% actives, more preferably between about 0.5 and about 5% actives, and most preferably between about 1% and about 5% actives. In use solution, the coupling agent is preferably in an amount between about 0.5 and about 2000 ppm actives, more preferably between about 1 and about 1000 ppm actives, more preferably between about 5 and about 750 ppm actives, and most preferably between about 20 and about 500 ppm actives.

### Buffer System

The enzymatic detergent compositions comprise a buffer system. Preferred buffers of the buffer system include, but are not limited to, alcohol amines, C1-C10 short chain carboxylic acids, alkali metal carbonates, bicarbonates, sesquicarbonates, and mixtures thereof. Preferred C1-C10 short chain carboxylic acid includes but are not limited to, formic acid, acetic acid, citric acid, tartaric acid, propionic acid, butanoic acid, pentanoic acid, hexanoic acid, heptanoic acid, octanoic acid, nonanoic acid, decanoic acid, lactic acid, maleic acid, oxalic acid, malonic acid, succinic acid, glutaric acid, adipic acid, pimelic acid, and suberic acid. In a preferred embodiment of an enzymatic detergent composition, preferred buffers include, but are not limited to, ethanolamine, methanolamine, triethanolamine, C1-C10 short chain carboxylic acid, or a mixture thereof. In a most preferred embodiment of an enzymatic detergent composition, most preferred buffers include, but are not limited to, methanolamine, triethanolamine, or a mixture thereof.

In a preferred embodiment of an enzymatic detergent composition, the buffer is preferably in an amount between about 0.1 and about 25% actives, more preferably between about 0.1 and about 20% actives, more preferably between about 0.5 and about 20% actives, and most preferably between about 1 and about 15% actives. In use solution, the buffer is preferably in an amount between about 0.5 and about 5000 ppm actives, more preferably between about 1 and about 3000 ppm actives, more preferably between about 5 and about 2000 ppm actives, and most preferably between about 20 and about 1500 ppm actives.

### Water

The enzymatic detergent compositions comprise water. In a preferred embodiment of an enzymatic detergent composition, the water is preferably in an amount between about 20 and about 80% actives, more preferably between about 20 and about 75% actives, more preferably between about 20 and about 70% actives, and most preferably between about 25 and about 65% actives. In use solution, water is the predominant ingredient and is added to Quantum satis (Q.S.).

### Additional Ingredients

The enzymatic compositions can comprise a number of additional ingredients. The additional ingredients can be added in an amount sufficient to impart the desired property or functionality. Exemplary additional ingredients, include, but are not limited to, alkalinity sources, aminocarboxylates, corrosion inhibitors, defoamers, dyes, phosphonates, preservatives, salt, surfactants, water conditioning agents, and combinations thereof.

In a preferred embodiment of an enzymatic detergent composition, the additional ingredients is preferably in an amount between about 0 and about 25% actives, more preferably between about 0.01 and about 25% actives, more preferably between about 0.01 and about 20% actives, and most preferably between about 0.1 and about 20% actives. In use solution, optional ingredients are preferably in an amount between about 0 and about 5000 ppm actives, more preferably between about 0.5 and about 4000 ppm actives, more preferably between about 1 and about 3000 ppm actives, and most preferably between about 2 and about 2000 ppm actives.

### Salt

The enzymatic detergent compositions can optionally comprise a salt. Salts generally include a cation with an anion. The cations may be selected from aluminum, ammonium, barium, calcium, magnesium, potassium, sodium, and zinc. Preferably, the cations are selected from magnesium, sodium, and potassium. The anions may be selected from Cl—, F—, HCO3-, CO32-, PO43-, NO3-, C₁-C₃ carboxylates (including, but not limited to, oxalate, citrate, and acetate), sulfide, sulfite, sulfate, and polyphosphate anions. Preferably, the anions are selected from C₁-C₃ carboxylates, chloride, and sulfate. Preferred salts include, for example, magnesium carbonate, calcium carbonate, sodium chloride, sodium carbonate, sodium citrate, sodium oxalate, and the like. More preferably, the salts do not include calcium, nitrates, or phosphonates. In an embodiment, the salt is formed by the buffer system components reacting and forming a salt in situ. Thus, the detergent can comprise a salt, but a salt is not always added to it as it may be formed by the reaction of an acid and base, when both are present in the buffer system.

Conductivity is commonly used for dosing and controlling caustic-based dairy CIP. A natural consequence of reducing or eliminating caustic in a formulation is a drastically lower conductivity. Without being bound by theory, the salt can be included into the composition to further bolster conductivity and assist in measuring conductivity of the composition in CIP systems. Thus, in a preferred embodiment, the enzymatic detergent compositions comprise a salt.

In a preferred embodiment of an enzymatic detergent composition, the salt is preferably in an amount between about 0 to about 20% actives, more preferably between about 2 to about 15% actives, most preferably between about 5 to about 12% actives. In use solution, the salt is preferably in an amount between about 0 to about 4000 ppm actives, more preferably between about 40 to about 1500 ppm actives, most preferably between about 100 to about 1200 ppm actives.

### Additional Enzymes

The enzymatic detergent compositions can comprise additional enzymes in addition to the protease. Additional suitable enzymes can include, but are not limited to amylase, cellulase, lipase, cutinases, peroxidases, gluconases, an additional protease, or mixtures thereof. If an additional enzyme is included in the compositions it is preferably in an amount between about 0 and about 10% actives, more preferably between about 0.01 and about 10% actives, more preferably between about 0.1 and about 5% actives, and most preferably between about 0.1 and about 5% actives. In use solution, optional ingredients are preferably in an amount between about 0 and about 200 ppm actives, more preferably between about 0.01 and about 175 ppm actives, more preferably between about 0.1 and about 150 ppm actives, and most preferably between about 0.5 and about 100 ppm actives.

### Corrosion Inhibitors

The enzymatic detergent compositions can optionally include a corrosion inhibitor. Exemplary corrosion inhibitors include an alkaline metal silicate or hydrate thereof, phosphino succinate, or combination thereof. Exemplary alkali metal silicates include powdered, particulate or granular silicates which are either anhydrous or preferably which contain water of hydration (between about 5 and about 25% actives, preferably between about 15 and about 20% actives water of hydration). These silicates include sodium silicates and have a Na₂O:SiO₂ ratio of about 1:1 to about 1:5, respectively. If a corrosion inhibitor is included in the compositions, it is preferably in an amount between about 0.01 and about 10% actives. In use solution, the corrosion inhibitor is preferably in an amount between about 0.05 to about 2000 ppm actives.

### Defoamers

The enzymatic detergent compositions can optionally include a defoamer and/or foam inhibitor. The compositions preferably do not foam or have foam that breaks promptly upon formation. Adding a defoamer and/or foam inhibitor can assist in preventing foam and reducing any foam's stability such that it can break promptly.

Suitable defoamers include silicon compounds such as silica dispersed in polydimethylsiloxane, fatty amides, amides, hydrocarbon waxes, fatty acids and soaps thereof, fatty esters, fatty alcohols, fatty acid soaps, sulfates and sulfonates, ethoxylates, vegetable oils, mineral oils and their sulfonated or sulfated derivatives, polyethylene glycol esters, block copolymers, including for example, difunctional block copolymers and polyoxyethylene-polyoxypropylene block copolymers, alkyl phosphates and phosphate esters such as alkyl and alkaline diphosphates, tributyl phosphates, and monostearyl phosphate, halogenated compounds such as fluorochlorohydrocarbons, and the like. If a defoamer is included in the enzymatic detergent compositions, it is preferably present in an amount sufficient to provide the desired defoaming properties. If a defoamer is included in the compositions, it is preferably in an amount between about 0.01 and about 10% actives, more preferably between about 0.1 and about 8% actives, most preferably between about 0.5 and about 5% actives. In use solution, the defoamer is preferably in an amount between about 50 ppb to about 2000 ppm actives, more preferably between about 0.5 to about 1600 ppm actives, most preferably between about 10 to about 500 ppm actives.

### Dyes

The enzymatic detergent compositions can optionally include a dye. Preferred dyes, include, but are not limited to, Violet Dye 148 (Keycolour), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), and Acid Green 25 (Ciba-Geigy).

In a preferred embodiment, the enzymatic detergent compositions are free of a dye. If a dye is included in the compositions, it is preferably in an amount between about 0.005 and about 10% actives. If a dye is included in the use solution, it is preferably in an amount between about 25 ppb and about 10 ppm actives.

### Phosphonates

The enzymatic detergent compositions can optionally include a phosphonate.

Examples of phosphonates include, but are not limited to: phosphinosuccinic acid oligomer (PSO) described in U.S. Pat. Nos. 8,871,699 and 9,255,242; 2-phosphinobutane-1,2,4-tricarboxylic acid (PBTC), 1-hydroxyethane-1,1-diphosphonic acid, CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₍₂₈₋ₓ₎N₃NₐxO₁₅P₅ (x=7); hexamethylenediamine (tetramethylenephosphonate), potassium salt, C₁₀H₍₂₈₋ₓ₎N₂KₓO₁₂P₄ (x=6); bis(hexamethylene)triamine (pentamethylenephosphonic acid), (HO₂)POCH₂N[(CH₂)₂N[CH₂PO(OH)₂]₂]₂; monoethanolamine phosphonate (MEAP); diglycolamine phosphonate (DGAP) and phosphorus acid, H₃PO₃. Preferred phosphonates are PBTC, HEDP, ATMP and DTPMP. A neutralized or alkali phosphonate, or a combination of the phosphonate with an alkali source prior to being added into the mixture such that there is little or no heat or gas generated by a neutralization reaction when the phosphonate is added is preferred. In one embodiment, however, the composition is phosphorous-free.

If a phosphonate is included in the compositions, it is preferably in an amount between about 0.01 and about 30% actives; more preferably between about 0.5 and about 25% actives, most preferably between about 1 and 10% actives. In use solution, the phosphonate is preferably in an amount between about 50 ppb to about 6000 ppm actives, more preferably between about 2.5 to about 5000 ppm actives, most preferably between about 20 to about 1000 ppm actives.

### Preservatives

The enzymatic detergent compositions can optionally include a preservative. Suitable preservatives include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol. Exemplary quaternary antimicrobial agents include benzalconium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their microbial properties. Other exemplary preservatives include gluteraldehyde, Bronopol, silver, and isothiazolones such as methylisothiazolinone. Preferred preservatives include those sold under the tradename Neolone™.

If a preservative is included in the compositions, it is preferably in an amount between about 0.01 and about 10% actives. If a preservative is included in the use solution, it is preferably in an amount between about 50 ppb and about 2000 ppm actives.

### Use Compositions

The compositions as described herein can be prepared as concentrated compositions or as use compositions. The concentrated compositions can be diluted to form a use composition consistent with the concentrations described above and further below.

### Methods of Use

The enzymatic caustic compositions are particularly useful as cleaning compositions for various dairy processing surfaces, including dairy clean-in-place (“CIP”) systems and dairy clean-out-of-place (“COP”) systems, including, but not limited to the CIP and COP components such as tanks, lines, and heat exchangers. CIP systems typically include, but are not limited to, a pre-rinse to remove soils, detergent circulation to remove residual adhering debris and scale, an intermediate rinse to remove the detergent, a disinfectant circulation, and a final rinse. Similarly, COP systems can include cleaning, which follows a sequence of steps such as prerinse, detergent, intermediate rinsing, sanitizing, and a final rinse, or can include spray cleaning or other cleaning operations that do not require the circulation as needed in CIP systems. COP tanks can include cleaning in a sequence including, but not limited to, submerging one or more substrates in the COP tank, adding the enzymatic caustic compositions to the tank (before or after the submerging step), cleaning the one or more substrates in the tank, draining the tank and/or removing the one or more substrates. The enzymatic caustic free cleaning compositions beneficially remove various types of soils, e.g. proteins, while also being compatible with food processing in both CIP and COP systems. Protein soil residues, often called protein films, occur in all food processing industries but the problem is greatest for the dairy industry, including milk and milk products producers, because dairy products are among the most perishable of major foodstuffs and any soil residues have serious quality consequences.

As noted above, the present methods are useful in the cleaning of dairy processing equipment, including dairy processing systems and components thereof (e.g., dairy processing equipment for processing milk, cheese, ice cream and other dairy products). Preferred dairy processing systems include, but are not limited to, dairy CIP systems and/or dairy COP systems. Dairy processing components, including, but are not limited to, heat exchangers, tanks, vats, lines, pumps, hoses, and combinations thereof.

Generally, the actual cleaning of the in-place system or other surface (i.e., removal of unwanted offal therein) can be accomplished with a different material such as a formulated detergent which is introduced with heated water. After this cleaning step, the composition can be applied or introduced into the system at a use solution concentration in unheated, ambient temperature water. In some embodiments, the composition remains in solution in cold (e.g., 4° C.) water and heated (e.g., 60° C.) water.

The compositions are preferably circulated through the process facilities for 90 minutes or less, more preferably 60 minutes or less, most preferably 50 minutes or less.

The present methods can use any suitable concentration of the compositions disclosed herein. For example, the composition can be used at a concentration of from about 1 ppm to about 100,000 ppm of the composition, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, or 90,000-100,000 ppm.

The present methods can comprise contacting a surface with an effective amount of the composition for any suitable amount of time. In some embodiments, the present methods can comprise contacting a surface with an effective amount of the compositions disclosed herein for from about 1 minute to about 3 hours, e.g., about 1 minute, 2 minutes, 3 minutes, 4 minutes, 5 minutes, 6 minutes, 7 minutes, 8 minutes, 9 minutes, 10 minutes, 20 minutes, 30 minutes, 40 minutes, 50 minutes, 1 hour, 2 hours, or 3 hours.

Preferably, the enzymatic detergent compositions are provided in a single step or a multi-step to clean.

The various surfaces to which the compositions can be applied can include any conventional application means. Application of the cleaning compositions in non-CIP systems and non-COP applications can include, for example, by wiping, spraying, dipping, immersing, or the like with a use solution of the solid composition, or dissolving and soaking with the use solution. The contacting step allows the composition to contact the soiled surface for a predetermined amount of time. The amount of time can be sufficient to allow, including from a few seconds to 90 minutes, from about 15 seconds, or about 30 seconds to about 90 minutes, or any range therebetween. In a preferred embodiment, the contact time required for antiviral efficacy is less than about 90 minutes, less than about 75 minutes, or less than about 60 minutes.

In some aspects, the methods can further include a precleaning step, such as where a cleaning composition is applied, wiped and/or rinsed, and thereafter followed by the applying of the compositions. The methods of use thereof can include treating cleaned or soiled surfaces with a sanitizing composition.

In some aspects, the methods do not require a rinse step. In some embodiments, the compositions are food contact approved and do not require a rinse step. As a further benefit, the methods do not cause corrosion and/or interfere with surfaces (e.g. hazy, dull or other negative aesthetic effects on the surface).

Temperature conditions for the methods can range from about 4° C.-71° C., about 15.5° C.-60° C., or about 21° C.-60° C. Temperature conditions for rinsing can also include temperatures of up to about 82° C.

All publications and patent applications in this specification are indicative of the level of ordinary skill in the art to which this invention pertains. All publications and patent applications are herein incorporated by reference to the same extent as if each individual publication or patent application were specifically and individually indicated as incorporated by reference.

### PREFERRED EMBODIMENTS

1. 1. A method of cleaning a dairy processing system comprising:
circulating a first dose of a cleaning composition to the dairy CIP system; wherein the cleaning composition comprises a serine protease enzyme; a surfactant comprising an alkylpolyglucoside, an EO-PO block copolymer, an alcohol alkoxylate, and/or mixtures thereof; a water conditioning agent comprising an aminocarboxylic acid, acrylic acid, polycarboxylic acids, salts of the foregoing, and/or mixtures thereof; a C2-C10 polyol; a buffer system; and water; wherein the pH of the cleaning composition is between about 6 and about 11;
monitoring the cleaning composition during the cleaning of the dairy processing system; adjusting the concentration of the cleaning composition by adding additional water
   and/or an additional dose of the cleaning composition to the dairy processing system.

2. The method of embodiment 1, wherein monitoring the cleaning composition comprises monitoring the conductivity of the cleaning composition.

3. The method of any one of embodiments 1-2, wherein the conductivity is monitored by measuring the conductivity of at least one salt of the cleaning composition.

4. The method of embodiment 3, wherein the conductivity of the salt of the cleaning composition is below 5000 μS/cm.

5. The method of embodiment 3, wherein the conductivity of the salt of the cleaning composition is below 1000 μS/cm.

6. The method of any one of embodiments 1-5, wherein the monitoring the cleaning composition comprises monitoring the pH of the cleaning composition.

7. The method of embodiment 1-6, wherein the cleaning composition further comprises at least one coupling agent.

8. The method of any one of embodiments 1-7, wherein the method is performed at a temperature of from about 40° C. to about 95° C.

9. The method of any one of embodiments 1-8, wherein the cleaning composition is circulated through the system for 90 minutes or less.

10. The method of any one of embodiments 1-9, wherein the cleaning composition is provided in a multi-part system.

11. A caustic free liquid cleaning embodiment for dairy processing systems and components thereof comprising:
a serine protease enzyme;
from about 0.5 to about 20% actives of a surfactant comprising an alkylpolyglucoside, an EO-PO block copolymer, an alcohol alkoxylate, and/or a mixture thereof;
from about 0.1 to about 10% actives of a water conditioning agent; wherein the water conditioning agent comprises an aminocarboxylic acid, acrylic acid, polyacrylic acid, and/or a mixture thereof;
a C2-C10 polyol;
a buffer system comprising an acid and/or a base; and
water; wherein the composition has a pH of from about 6 to about 11.

12. The composition of embodiment 11, further comprising from about 2 to about 15% actives of a salt; wherein the salt is for conductivity monitoring of the liquid cleaning composition and comprises an anion selected from the group consisting of a carboxylate, a chloride, a sulfate, and mixtures thereof; and wherein the salt comprises a cation selected from the group consisting of magnesium, sodium, potassium, and mixtures thereof.

13. The composition of any one of embodiments 11-12, wherein the salt is from about 5 to about 12% actives.

14. The composition of any one of embodiments 11-13, further comprising from about 0.1 to about 10% actives of at least one coupling agent.

15. The composition of embodiment 14, wherein the at least one coupling agent comprises one or more of the following sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and sodium butylnaphthalene.

16. The composition of any one of embodiments 11-15, wherein the buffer system comprises an ethanolamine and/or a C1-C10 carboxylic acid.

17. The composition of any one of embodiments 11-16, wherein the cleaning composition further comprises an additional surfactant.

18. The composition of any one of embodiments 11-17, wherein the cleaning composition further comprises a pH adjuster.

19. The composition of any one of embodiments 11-18, wherein the surfactant comprises a mixture of at least two of an alkylpolyglucoside, an EO-PO block copolymer, and an alcohol alkoxylate.

20. The composition of any one of embodiments 11-19, wherein the surfactant comprises each of an alkylpolyglucoside, an EO-PO block copolymer, and an alcohol alkoxylate.

21. The composition of any one of embodiments 11-20, wherein the cleaning composition is used for cleaning a dairy CIP system or a dairy COP system.

22. The composition of embodiment 21, wherein the cleaning composition is provided as a multi-part system to a dairy CIP system or a dairy COP system.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1

### Cleaning Performance Evaluation.

Due to the nature of the soil at being dairy based, cheese was baked onto melamine tiles cheese tiles which were used to screen performance. Formulations are made and used to clean the cheese tiles at different temperatures and for varying amounts of contact time. This method can be used to screen individual formula components and differentiate between formulas quickly and repeatably. Performance is recorded in terms of L units, a light-dark reflection value which captures the darkness of the cheese tile before and after cleaning using a HunterLab colorimeter. A larger Delta L correlates to a tile that has been cleaned to a greater extent.

Initial testing compared the cleaning of a cheese tile using a simple enzyme and buffer system to an inline built caustic food and beverage formulation. This experiment was performed at 75° C. The buffer system consisted of 1000 ppm sodium bicarbonate, and was pH adjusted with acid to a pH of 9.5. FIG. 1 shows the Delta L over a period of from 0 to 40 minutes.

This concentration gradient of protease showed the benefits of different amounts of enzyme. It was determined that because of the unknown ability of the test method to transfer to the field, the most enzyme that could be feasibly afforded should be used. This led to a protease dosage of 0.3% active in an exemplary formulation, Formula A, as shown in Table 2. Formula A allowed for 30 ppm of protease to be dosed, which is in line with a sizable performance boost from the inline chemistry according to the cheese tile experiments performed (when dosed at 75° C.).

TABLE 2

| Formula A | % Active |
|---|---|
| Water | 62.00 |
| Sodium bicarbonate | 5.00 |
| Monoethanolamine | 2.57 |
| tris(monoethanolamine) citrate | 4.88 |
| Glycerin | 9.97 |
| C8-C10 Polyglucoside | 4.03 |
| Sodium Polyacrylate | 2.64 |
| EO-PO-EO Block Copolymer, 10% EO | 5.47 |
| Sodium Xylene Sulfonate | 1.26 |
| Propylene glycol | 1.19 |
| Sodium formate | 0.30 |
| Enzyme stabilizer | 0.03 |
| Serine Protease | 0.30 |

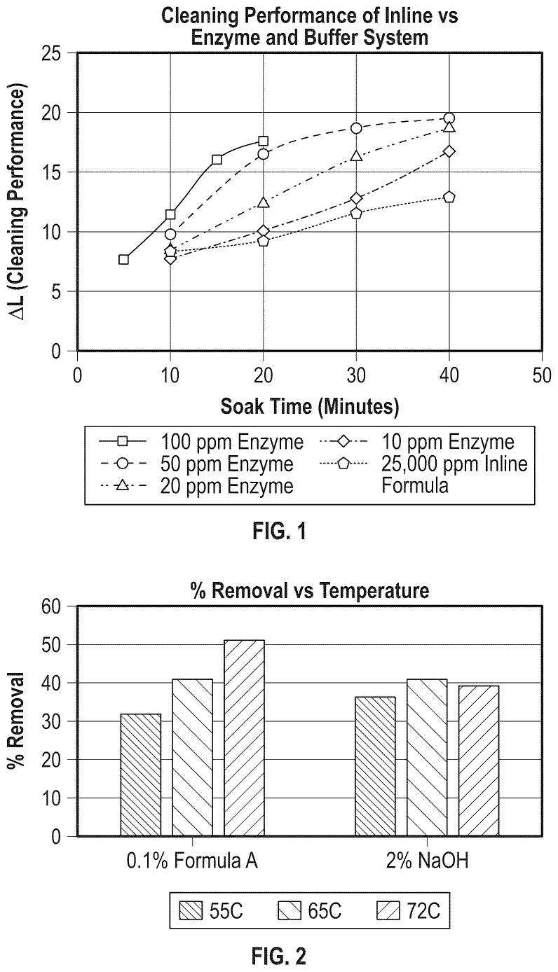

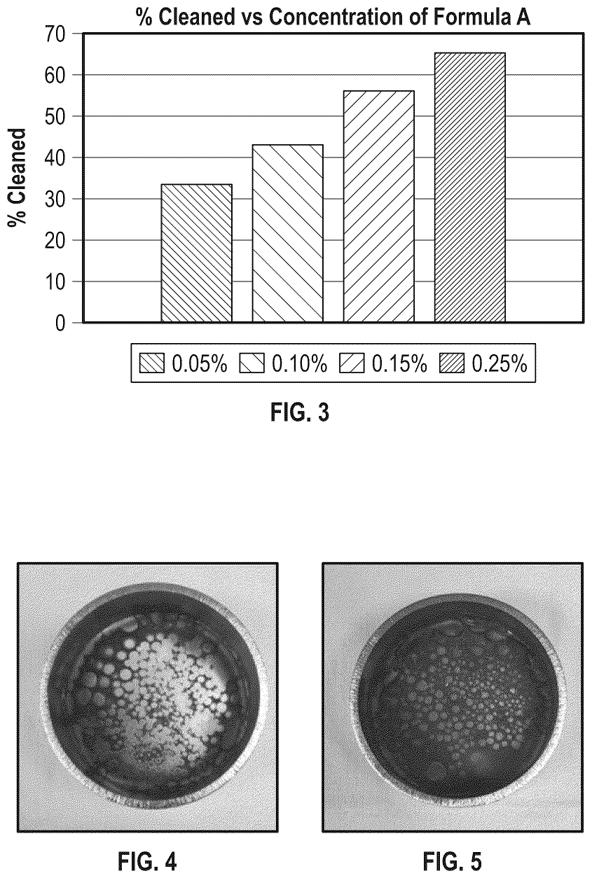

After it was established that the selected serine protease (derived from Subtilisin) could perform at least as well as 2.5% of the inline chemistry, additional comparisons were made to understand the effect of temperature and enzymatic dose for cleaning. FIG. 2 and FIG. 3 illustrate the cleaning performance of Formula A at various temperatures and dosage amounts. FIG. 2 shows the cleaning efficacy of 0.1% of Formula A against a commercially available alkaline CIP detergent at 55° C., 65° C., and 72° C. FIG. 3 shows the cleaning efficacy of 0.05%, 0.1%, 0.15%, and 0.25% of Formula A at 65° C.

FIG. 2 shows that at a significantly less amount, 0.1% of Formula A performed about the same (at 55° C.) or better (at 65° C. and 72° C.) than 2% of the alkaline formula. Moreover, comparing against the results of FIG. 2, FIG. 3 shows that at 65° C., lower amounts of Formula A were needed for better % removal performance than the alkaline formula, with only 0.25% of Formula A providing approximately 65% removal of soil compared to only approximately 38% removal for 2% of the alkaline formula.

An additional cheese tile cleaning test was conducted to screen a variety of serine proteases (seven different serine protease products) sourced from different manufacturers (including BASF, IFF, and Novonesis). The serine proteases were in buffered media of varied pH at 70° C. All of the serine proteases tested demonstrated improved cleaning performance at pHs of about 7 to about 9.

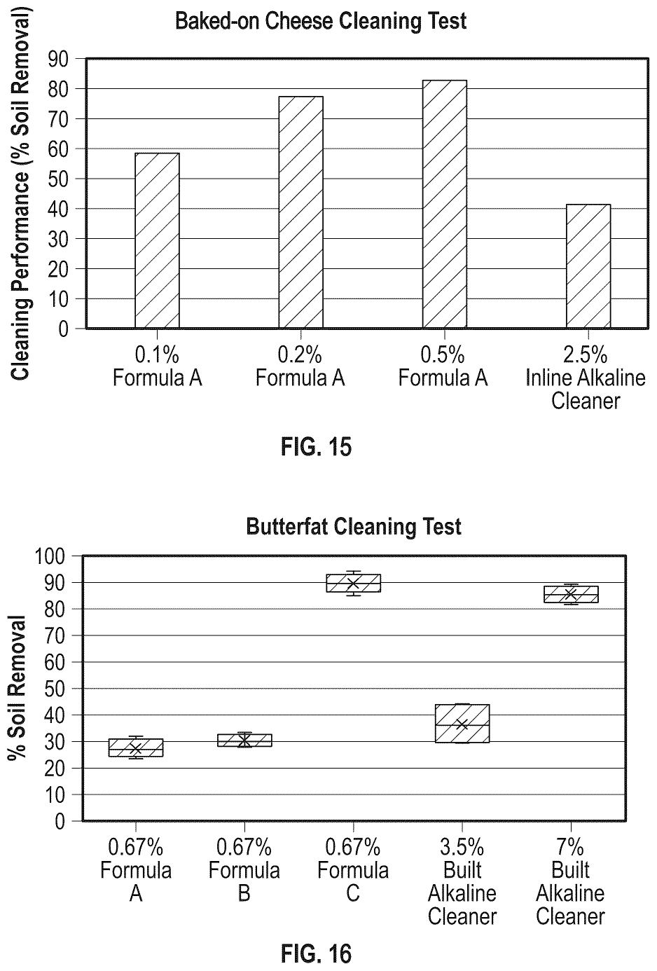

The ability of the Formula A to remove protein was tested against a built alkaline cleaner testing the cleaning compositions on the melamine tiles soiled with baked on cheese; the results are shown in FIG. 15. Notably Formula A was shown to remove high-protein dairy soils at much lower concentrations relative to the built alkaline formula under these conditions.

### Example 2

### Hot-Process Dairy Soil Cleaning Test Performance.

An additional performance metric was also identified as having carryover to real-world customer applications. A dairy creamer was baked onto stainless-steel coupons at high temperatures for 80 minutes to mimic burnt on soils in dairy applications. The soiled stainless-steel coupons were then placed in 150 mL of 70° C. distilled water to hydrate the coupon for 20 minutes. Then, the coupons were transferred to 150 mL of 70° C. Formula A or a NaOH control formula for 45 minutes of cleaning. After the 45 minutes, the coupons were transferred to vat with running DI water and then allowed to sit for 5 minutes to remove floating soil leftover on the coupon. Next, the coupon was dried in an oven at 50° C. and fanned to maximize evaporation. The mass of the soiled coupon prior to cleaning was compared to the mass of the respective coupon post cleaning to evaluate the formulas efficacy of burnt dairy soil removal.

Visual representation of the cleaning performance of Formula A and a NaOH control are shown in FIG. 4 and FIG. 5. As shown in FIG. 4, 0.5% of Formula A was able to clean the burnt creamer off of the stainless steel better than 2% of the NaOH control shown in FIG. 5.

### Example 3

### Conductivity Performance.

Conductivity is commonly used for dosing and controlling caustic-based dairy CIP. A natural consequence of reducing or eliminating caustic in a formulation is a drastically lower conductivity. Formula A was tested to determine the conductivity at different concentrations. Conductivity results from 0-1.5% of Formula A are shown in Table 3, below. Even at the highest dose the conductivity is below 2000 μS/cm.

TABLE 3

| % Formula A | μS/cm |
|---|---|
| 0 (DI Water) | 1.5 |
| 0.1 | 160 |
| 0.25 | 368 |
| 0.5 | 641 |
| 1 | 1290.47 (Extrapolated) |
| 1.5 | 1924.02 (Extrapolated) |

It is possible to increase the conductivity of a formula by adding various salts. However, this can also introduce physical stability issues by salting out other formulation components or causing incompatibility with customer equipment. Various salts were screened to maximize conductivity while minimizing these potential problems. As such, in addition to Formula A described in Table 2, Formulas B-E were developed with various salts as shown in Tables 4-7.

TABLE 4

| Formula B | % Active |
|---|---|
| Water | 61.97 |
| Sodium bicarbonate | 5.00 |
| Monoethanolamine | 2.57 |
| Tris(monoethanolamine) citrate | 4.88 |
| Sodium acetate | 6.30 |
| Sodium chloride | 3.50 |
| Glycerin | 9.97 |
| Propylene glycol | 0.59 |
| C8-C10 Polyglucoside | 0.81 |
| Sodium polyacrylate | 0.53 |
| Sodium cumene sulphonate | 2.40 |
| Sodium formate | 0.15 |
| Enzyme stabilizer | 0.02 |
| EO-PO-EO Block Copolymer, 10% EO | 1.10 |
| Serine Protease | 0.15 |

TABLE 5

| Formula C | % Active |
|---|---|
| Water | 58.34 |
| Sodium bicarbonate | 3.16 |
| Monoethanolamine | 1.24 |
| Triethanolamine acetate | 3.41 |
| Triethanolamine | 0.04 |
| Sodium carbonate | 4.97 |
| Propylene glycol | 0.59 |
| Glycerin | 14.96 |
| C10-16 Polyglucoside | 1.20 |
| Sodium polyacrylate | 0.53 |
| Poly(alkylene oxide 2EO, 4PO) | 0.35 |
| substituted C12-14 Alkanols | |
| Methyl glycine diacetic acid | 0.16 |
| Sodium formate | 0.15 |
| Sodium Chloride | 3.50 |
| Sodium Acetate | 3.15 |
| Sodium cumene sulphonate | 1.60 |
| Enzyme stabilizer | 0.02 |
| Serine Protease | 0.15 |

TABLE 6

| Formula D | % Active |
|---|---|
| Water | 59.18 |
| Sodium bicarbonate | 3.17 |
| Monoethanolamine | 1.24 |
| Triethanolamine acetate | 3.41 |
| Triethanolamine | 0.04 |
| Sodium polyacrylate | 0.53 |
| Sodium formate | 0.08 |
| Methyl glycine diacetic acid | 0.16 |
| Propylene glycol | 0.27 |
| Glycerin | 14.96 |
| Sodium carbonate | 4.95 |
| Sodium acetate | 3.15 |
| Sodium cumene sulphonate | 1.60 |
| Poly(alkylene oxide 2EO, 4PO) | 0.26 |
| substituted C12-14 Alkanols | |
| C10-16 polyglucosides | 0.90 |
| Sodium Chloride | 3.50 |
| Enzyme stabilizer | 0.01 |
| Serine Protease | 0.08 |

TABLE 7

| Formula E | % Active |
|---|---|
| Water | 45.96 |
| Sodium bicarbonate | 2.67 |
| Monoethanolamine | 2.48 |
| Triethanolamine citrate | 6.96 |
| Monoethanolamine carbonate | 5.75 |
| Triethanolamine | 0.09 |
| Sodium formate | 1.00 |
| Monoethanolamine citrate | 0.12 |
| Propylene glycol | 3.95 |
| Glycerin | 29.91 |
| Enzyme Stabilizer | 0.10 |
| Serine Protease | 1.00 |

TABLE 8

| | | % active | % active | Physical | Material |
|---|---|---|---|---|---|
| Formula | Salt | Coupler | Defoamer | Stability | Stability |
| A | N/A | 1.26 | 5.47 | Yes | Yes |
| B | NaCl | 3.5 | 1.1 | Yes | Yes |
| C | NaCl | 3.5 | 0.35 | Yes | Yes |
| D | NaCl/C₂H₃NaO₂ | 6.65 | 0.26 | Yes | Yes |

Table 8 shows that both formulations containing just NaCl and NaCl/C₂H₃NaO₂ showed physical and material stability in the liquid formulas. Thus, preference for specific salts may be dictated by various factors such as conductivity response, cost, material compatibility, and risk avoidance for including nitrates and/or sulfates into CIP/COP systems.

### Example 4

### Concentrate Stability Evaluation.

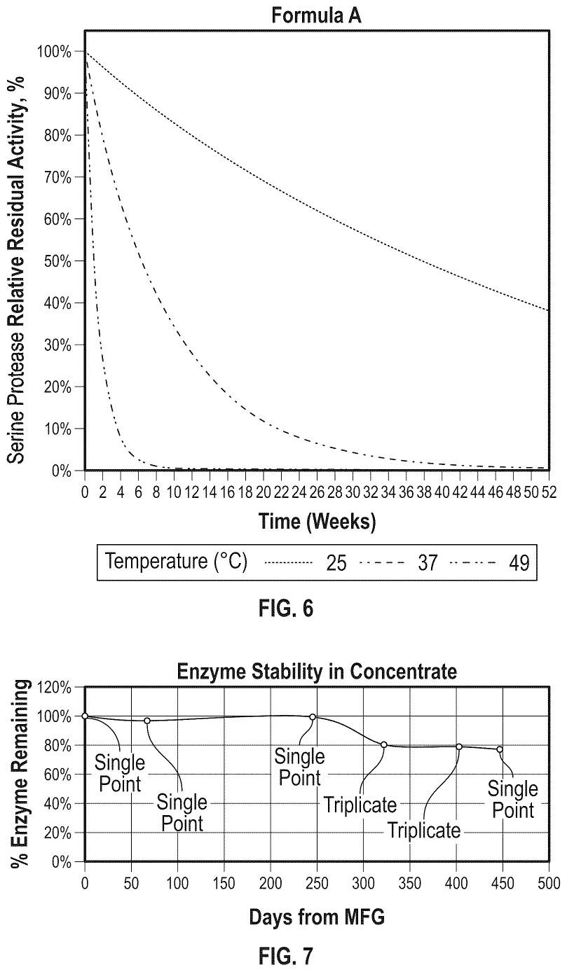

To determine the extent which the enzyme will degrade over time, experiments were performed holding the formulas at different temperatures for different lengths of time. These experiments were then used to create a predictive model to estimate enzyme degradation levels over greater lengths of time. Formula A was modeled at 25° C., 37° C., and 49° C. over 52 weeks. FIG. 6 shows that at 25° C., approximately 40% of the enzyme is modeled to remain after 52 weeks. Yet, when the formula was held at higher temperatures, the enzyme would not be projected to maintain activity during the entire 52 weeks, with less than 10% residual activity remaining at approximately 24 weeks at 37° C. and 4 weeks at 49° C.

Samples of Formula A were additionally measured for enzyme stability at ambient temperature (approximately 25° C.) for 450 days after initial manufacturing. The results are shown in FIG. 7.

From the collected data, there is a large difference between the predicted outcome at 25° C. and the experimentally gathered 25° C. data. Yet, both the predicted and collected data show that Formula A is able to maintain at least half of the enzyme activity after a year, with the collected data showing that Formula A is able to maintain approximately 80% of the enzyme activity after a year.

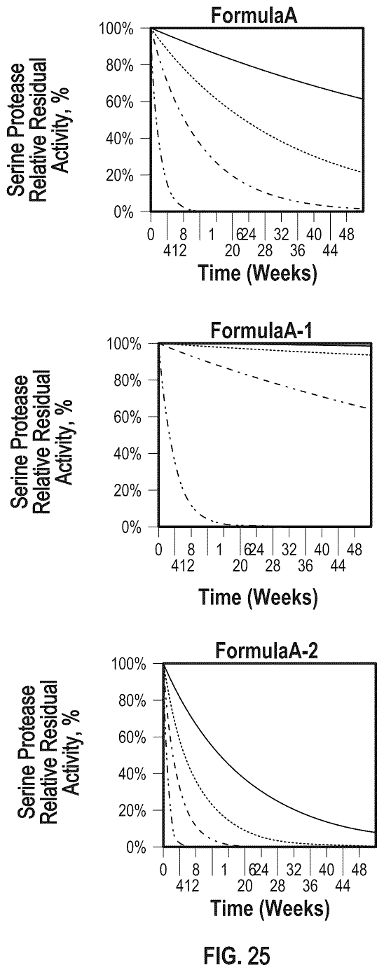

To ensure the stability of the enzyme in the concentrated detergent solution, numerous experiments were conducted. Generally, these experiments followed the Example 4. Several variations of Formula A were created and the enzyme stability of each was monitored over the course of several weeks at various temperatures. This data was fit and extrapolated out to allow for comparisons on the enzyme stability in the formulations to be made. FIG. 25 show the modeled enzyme activity over one year: with the top line representing 5° C., the second from the top line representing 25° C., the third from the top line representing 37° C., and the violet line representing 49° C. Formula A had a pH of 9.5, Formula A-1 had a pH of 8.5 and Formula A-2 had a pH of 10.2. FIG. 25 demonstrates that Formula A does not have ideal enzyme stability in the concentrate; however, it also demonstrates that the enzyme stability can be improved by lowering the formula pH or by decreasing the storage temperature.

### Example 5

### Bleach Compatibility Evaluation.

The use of hypochlorite in the dairy processing industry is widespread. General hypochlorite is used in cleaning, sanitizing, and treatment of reclaimed water. Enzymes are known to be susceptible to deactivation from oxidizing chemicals such as hypochlorite, even at very low levels. As hypochlorite residue may remain on the objects for CIP or even be included in the reclaimed water used to make up the use-dilution of a CIP cleaner, CIP cleaning formulas must be able to tolerate exposure to small amounts of hypochlorite without losing their cleaning efficacy. To this end, an experiment was performed on Formula A in which solutions of varying concentration were spiked with 50 ppm of hypochlorite to determine the level at which deactivation of the enzyme occurred. The solutions were prepared and then were heated to 70° C. for 10 min before the enzyme activity was assayed. The results of this experiment are shown in Table 9.

TABLE 9

| Active | Formula | Enzyme Activity |
|---|---|---|
| hypochlorite (ppm) | A (ppm) | Remaining |
| 0 | 500 | 100.0% |
| 50 | 5000 | 105.8% |
| 50 | 2500 | 103.6% |
| 50 | 1000 | 71.8% |
| 50 | 500 | 0.1% |

Table 9 demonstrates that the enzymatic formula at concentrations of 2500 ppm (0.25%) or higher could tolerate a high level of hypochlorite exposure without notable deactivation of the enzyme. The proposed mechanism involves the ethanolamines in the buffer, which rapidly combine with the hypochlorite to form less-oxidizing species upon mixing.

### Example 6

### Concentrate Enzyme Stability Performance.

Similar to Example 4, experiments were performed to determine the extent to which an enzyme will degrade over time. These experiments were then used to create a predictive model to estimate enzyme degradation levels over greater lengths of time. Formula E, as shown in Table 7 above, was modeled at 50° C. at 7 days and 14 days.

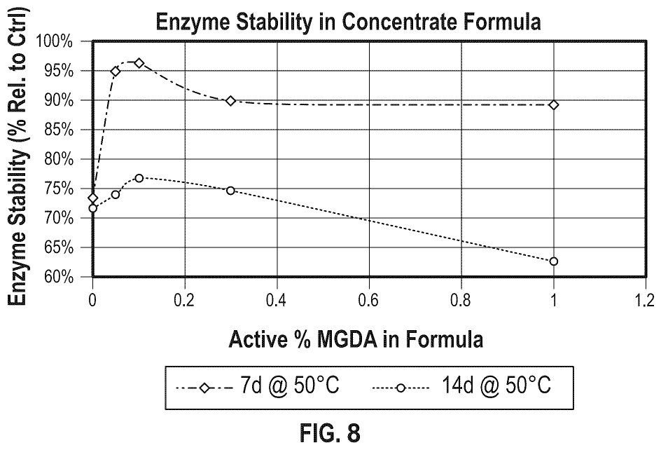

FIG. 8 shows the enzyme stability of formulas with various active percent amounts (0, 0.05, 0.1, 0.3, and 1%) of MGDA and the percent stability of the enzyme relative to a control. As can be seen, over 7 days the stability of the enzyme in the formulas are higher than when there is no MGDA chelant. Further, the stability of the enzyme over 14 days only the 1% of MGDA is lower than the formulation without MGDA. Without being limited by theory, these results may be potentially explained by two competing mechanisms: 1) some MGDA chelant in the formulation works to break down CaCO3, increasing Ca levels and increasing enzyme stability; and 2) too much MGDA chelant removes Ca from the solution, reducing enzyme stability.

### Example 7

### Enzyme Rinsing and Deactivation Evaluation.

Wash and rinse monitoring was conducted during tests of a caustic-based formula and Formula D as described above to validate that the respective rinsewater is free of residual enzyme after the rinse step is completed. The caustic-based formula rinsed active chlorine out of the system within 3 minutes and took 2 minutes to approach a neutral pH. Formula D rinsed enzyme out of the system within 1 minute; the surfactant and buffer washed out of the system within 2 minutes; and the rinsewater pH began lower than baseline and dropped to near neutral within 30 seconds.

### Example 8

### Biomass Compatibility.

A compatibility study was run with a sample of anerobic biomass used in dairy processing. The test consisted of 4 phases and various doses (0, 200, 400, 800, 1200, 1600, and 2000 ppm) of Formula C as provided above. In the 1^{st} phase biomass was grown with the addition of a nutritional substrate. In the 2^{nd} phase one dose of cleaning chemistry was introduced to the biomass along with the usual dose of substrate to test its response. In the 3^{rd} phase an additional dose of cleaning chemistry was introduced to the biomass to test the response of the biomass to repeated exposure. In the 4^{th} phase the biomass was grown using a substrate addition without cleaning chemistry to test the ability of the biomass to recover from the exposure.

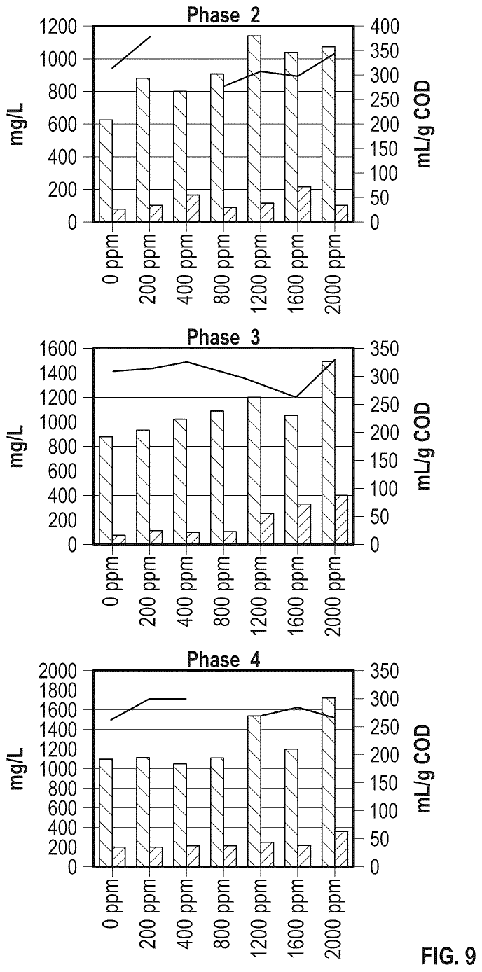

The results of the compatibility testing are shown in FIG. 9 which demonstrate that Formula C was found to be compatible with anerobic biomass at all concentrations tested. The biomass was able to recover from all doses of Formula C within one day and no inhibition in methane production or bacterial death was observed in any of the dosages. Based on its BOD to COD ratio, Formula C was also found to be readily biodegradable.

### Example 9

### Wash and Rinse Monitoring.

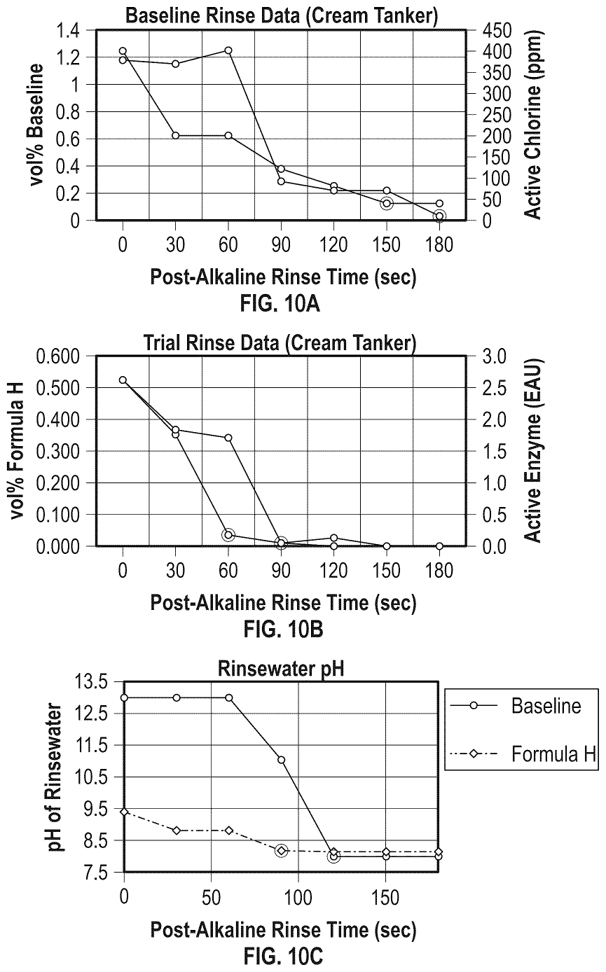

Wash and rinse monitoring was conducted during tests to validate that rinsewater is free of residual enzyme after the rinse step is completed. A baseline formula was compared to Formula D as described above. Post-rinse, the conductivity of the baseline formula normalized to water by 2.5 minutes, and the chlorine rinsed out by 3 minutes. Post-rinse, the conductivity of Formula D normalized to water by 1.5 minutes, and the enzyme rinsed out by 1 minute as shown in FIGS. 10A-B. FIG. 10C, which demonstrates that for the baseline formula, rinsewater pH goes to neutral at 2 minutes and for Formula D, the rinsewater pH does to neutral at 1.5 minutes. Formula D provided faster rinsing chemistry which allowed for rinsewater and time savings.

The results of the rinse reduction achieved by Formula D demonstrate the potential for rinsewater savings. Table 10 shows changes to the sanitation standard operating procedure (SSOP) achieved by Formula D as compared to the baseline chlorinated-alkaline CIP formula.

TABLE 10

| Step Number, Name | Baseline Duration | Formula H Duration |
|---|---|---|
| 15, Drain to Recovery | 0:20 | 0:20 |
| 17, Rinse to Recovery | 0:45 | 0:25 |
| 18, Drain to Recovery | 0:20 | 0:20 |
| 19, Rinse to Recovery | 0:30 | 0:25 |
| 20, Drain to Recovery | 0:30 | 0:20 |
| 21, Rinse to Recovery | 0:45 | 0:25 |
| 22, Drain to Recovery | 1:00 | 1:00 |

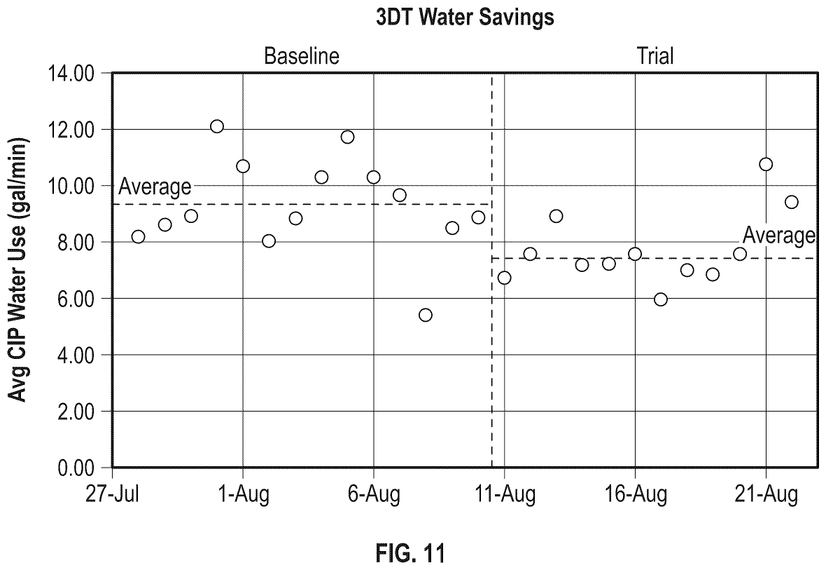

As Table 10 shows, the post-enzyme rinse duration (Formula H) was shortened by 22% (55 seconds) relative to the post-alkaline rinse (baseline formula). As FIG. 11 shows, an average water savings of approximately ˜20% was achieved by Formula H as compared to the baseline formula.

### Example 10

### Butterfat Cleaning Test to Evaluate Surfactant Blend Efficacy.

To soil the coupons for butterfat cleaning testing, stainless steel coupons were brushed with a homogenous layer of room temperature butterfat; a thin layer of butterfat was applied per coupon in a thin layer on one side and then the butterfat coupon was allowed to dry overnight. The surfactant blends were prepared by mixing the surfactant components and DI water while heating to 45 or 50° C. and then adjusting to the desired pH.

The soiled coupons were then inserted into beakers containing the prepared surfactant blends for 10 minutes of cleaning. After which, the coupons were dipped into DI water 3 times, for 2 seconds each dip, and then allowed to dry overnight. The cleaning efficacy of the various surfactant blends were evaluated by comparing the mass of the cleaned coupons to the mass of the same respective coupon prior to said cleaning.

While a proteolytic enzyme is an excellent candidate for removing soils high in dairy proteins, the enzyme will not facilitate the removal of soils high in milkfat. To improve the ability of the formula to remove these high-fat soils, a secondary active ingredient must be included to facilitate their removal.

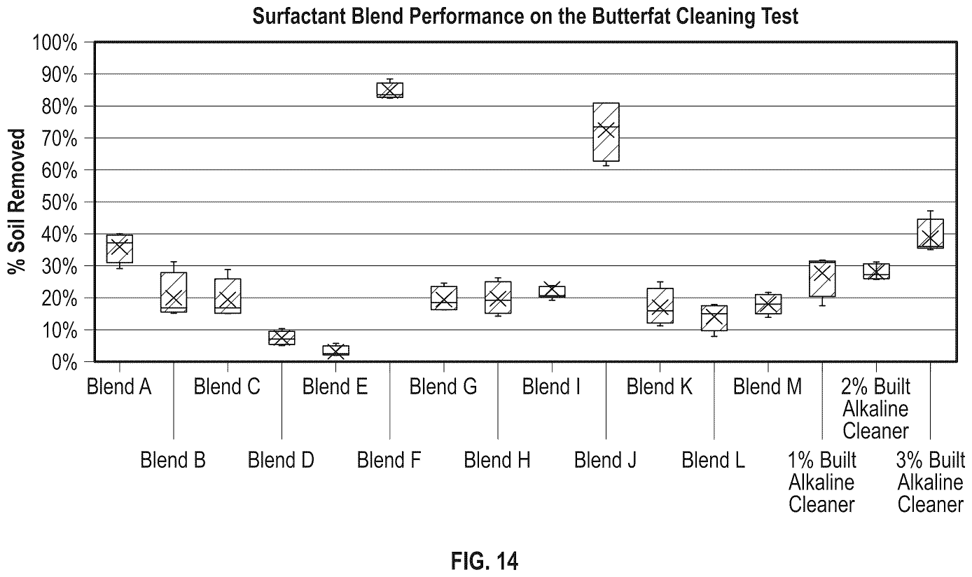

A series of surfactant blends were screened for their ability to remove milkfat from stainless steel via a Butterfat Cleaning Test. The surfactant blends tested are listed in Table 11, and FIG. 14 demonstrates their cleaning efficiency. All surfactant blends were tested with Component 1 at 200 ppm and Component 2 at 275 ppm in the cleaning solution.

TABLE 11

| Surfactant | | |
|---|---|---|
| Blend | Component 1 | Component 2 |
| Surfactant | C8-10 Polyglucosides, | Poly(alkylene Oxide) Block |
| Blend A | DP 1.7 | Copolymer: 2 EO, 30 PO, 2 EO |
| Surfactant | C8-10 Polyglucosides, | Poly(alkylene Oxide) Block |
| Blend B | DP 1.7 | Copolymer: 5 EO, 30 PO, 5 EO |
| Surfactant | C8-10 Polyglucosides, | Poly(alkylene Oxide) Block |
| Blend C | DP 1.7 | Copolymer: 12 EO, 30 PO, 12 |
| | | EO |
| Surfactant | C8-10 Polyglucosides, | Poly(alkylene Oxide) Block |
| Blend D | DP 1.7 | Copolymer: 20 PO, 15 EO, 20 |
| | | PO |
| Surfactant | C8-10 Polyglucosides, | Poly(alkylene Oxide) Block |
| Blend E | DP 1.7 | Copolymer: 20 PO, 35 EO, 20 |
| | | PO |
| Surfactant | C10-16 Polyglucosides, | Poly(alkylene Oxide) Block |
| Blend F | DP 1.5 | Copolymer: 2 EO, 30 PO, 2 EO |
| Surfactant | C10-16 Polyglucosides, | Poly(alkylene Oxide) Block |
| Blend G | DP 1.5 | Copolymer: 5 EO, 30 PO, 5 EO |
| Surfactant | C10-16 Polyglucosides, | Poly(alkylene Oxide) Block |
| Blend H | DP 1.5 | Copolymer: 12 EO, 30 PO, 12 |
| | | EO |
| Surfactant | 2-ethylhexyl | Poly(alkylene Oxide) Block |
| Blend I | Polyglucoside | Copolymer: 2 EO, 30 PO, 2 EO |
| Surfactant | C8-16 Polyglucosides, | Poly(alkylene Oxide) Block |
| Blend J | DP 1.5 | Copolymer: 2 EO, 30 PO, 2 EO |
| Surfactant | C8-10 Polyglucosides, | Poly(ethylene Oxide 7EO) |
| Blend K | DP 1.7 | substituted C12-15 Alkanols |
| Surfactant | C8-10 Polyglucosides, | Poly(ethylene Oxide 6EO) |
| Blend L | DP 1.7 | substituted C9-12 Alkanols |
| Surfactant | Poly(ethylene Oxide | Poly(alkylene Oxide) Block |
| Blend M | 7EO) substituted | Copolymer: 2 EO, 30 PO, 2 EO |
| | C12-15 Alkanols | |

Notably, several mixtures of alkyl polyglycolides (APG) with ethylene oxide-propylene oxide block copolymers (EO-PO) were shown to be particularly efficacious for removing milkfat soil from stainless steel. The performance was especially high in blends containing high molecular weight APGs and EO-POs with low molecular weight terminal ethylene oxide units. Surfactant Blends A, F, and J were found to remove high-fat soils as well or better than high doses of alkaline cleaner, making them ideal for use in formulations herein.

### Example 11

### Butterfat Cleaning Test to Evaluate Enzymatic Formulas.

The ability of the enzymatic Formulas A-C to remove high-milkfat soils was tested against a built alkaline cleaner using the Butterfat Cleaning Test as described in Example 11; the results are shown in FIG. 16. Notably, 0.67% Formula A was shown to remove soil similarly to a dose of 3.5% built alkaline cleaner whereas 0.67% Formula C was shown to remove soil similarly to a dose of 7% built alkaline cleaner.

### Example 12

### Cold-Process Cleaning Testing.

There are several cold-processes common to a majority of dairy processing plants including holding silos, blending tanks, transfer lines, and several other applications. These applications are commonly cleaned using chlorinated-alkaline cleaners or alkaline cleaners with added hypochlorite; these cleaners work by combining the protein removal from hypochlorite with the fat removal and emulsification of high pH. The viability of cleaning these same applications with the enzymatic formulas disclosed herein was tested via the Cold-Process Dairy Soil Cleaning Test which employs the methodology as follows.

Stainless steel coupons were soiled by dipping into whole milk, which was then allowed to dry down to a film. The dried coupons were then rinsed for 2.5 minutes in vials containing tap water (5 gpg) at 20° C. and then washed in the respective cleaning solution at a cleaning temperature of 65° C. for 2.5 minutes. The cleaned coupons were then momentarily rinsed in tap water (5 gpg) at 20° C. to remove any remaining cleaning solution and then were dried. The soiling, rinsing, cleaning, rinsing, and drying steps were repeated a number of times to allow residual soil to accumulate on the coupons. After the desired number of cycles had been completed, the coupons were stained with a protein-binding dye solution to make residual soil traces highly visible on the surface. Quantitative image analysis was used to evaluate the effectiveness of the various cleaning solutions.

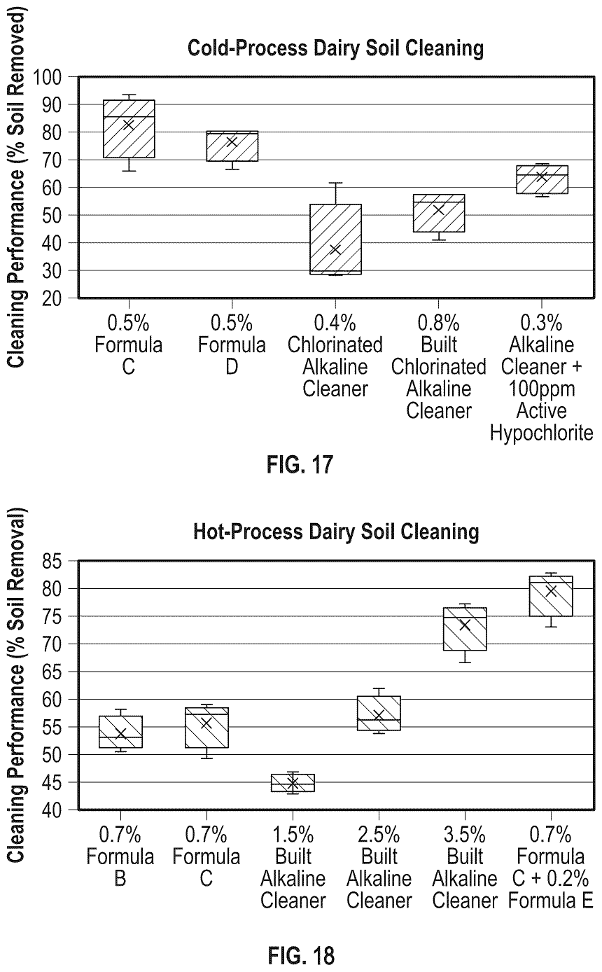

The results of the Cold-Process Dairy Soil Cleaning Test are demonstrated in FIG. 17. Notably, the enzymatic formulas show greatly enhanced performance at the concentrations tested.

### Example 13

### Hot-Process Cleaning Testing.

Almost all dairy processing facilities also have unit operations in which the product is heated. These applications will contain heat exchange surfaces which are often regarded as challenging to clean. The most common of these applications are pasteurizers, which heat various dairy products in order to kill microorganisms. These applications are commonly cleaned at high temperatures using high doses of alkaline cleaner. To test the viability of the enzymatic detergents disclosed herein on these types of soils, the Hot-Process Dairy Soil Cleaning Test methodology of Example 2 was used; the results of which are demonstrated in FIG. 18. For these heated applications, it was found that a larger dose of enzyme is required to achieve comparable cleaning efficiency. This dose of enzyme can either be applied as a single cleaner or in multiple parts dosed simultaneously.

### Example 14

### CIP Cleaning Performance; Field Tests A-C.

The cleaning performance of several of these formulas was also tested via field tests, in which the current cleaner was replaced with one of the enzymatic formulas. During these tests, the cleanliness was monitored after every CIP. Examples of cleaning data from some of the trials are given below.

Field Test A: a trial ran for four weeks; two where the performance of the baseline cleaner was monitored and two with the enzymatic cleaner. During the test, Formula C replaced an inline alkaline cleaner (which was supplemented with hypochlorite) that was used in a raw receiving CIP system to clean dairy processing equipment including milk tankers, raw milk silos, transfer lines, and pasteurized milk silos. The general CIP SOP was as follows: pre-rinse with reclaimed alkaline cleaner, wash with alkaline cleaner+hypochlorite, rinse with fresh water, apply sanitizer.

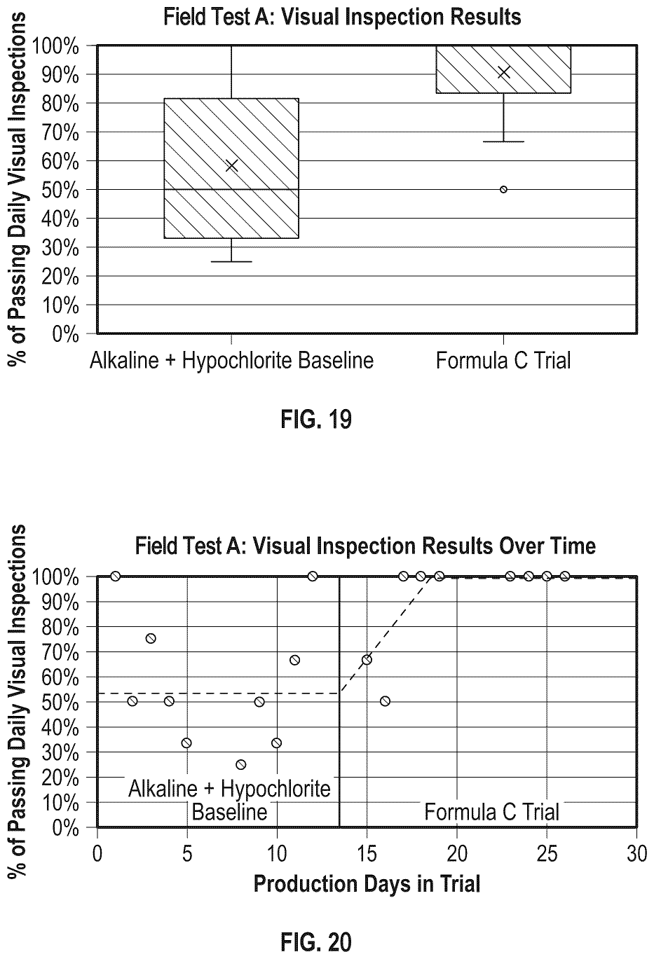

The cleaning performance was determined via visual inspection of the cleaned surfaces. As a different number of CIPs occurred daily, the baseline and trial data were compared based on the percentage of passing daily visual inspections. FIG. 19 shows the baseline data compared to the trial data; showing a clear increase in the percent of passing visual inspections during the trial period (p=0.007, significant).

If the same results are trended over time, as shown in FIG. 20, then it also becomes clear that the average shifted from 58% of post-CIP visual inspections passing to 100% of visual inspection passing after changing over to cleaning with Formula C. These results indicate that Formula C outperforms the cleaning performance of the alkaline cleaner+hypochlorite.

The concentrations of cleaner were titrated during every wash which was visually inspected. It was found that the baseline alkaline cleaner was dosed to a level of 0.15±0.09% active as sodium hydroxide (being approximately equivalent to 0.3% alkaline cleaner by volume) with an added 42±23 ppm of hypochlorite. The level of Formula C dosed during the trial was found to be 0.58±0.10% by volume.

Field Test B was conducted in two phases: phase one which contained a two week baseline period and a two week trial of Formula C, and phase two which contained a one month baseline followed by a three month trial of Formula D and Formula E. Formula C and Formula D were dosed at 0.5 vol % to CIP milk tankers, milk silos, whey silos, and acidified milk silos. During phase two, a mixture of 0.5 vol % Formula D with 0.15 vol % Formula E was used to clean the high-temperature short-time (HTST) pasteurizer. The cleaning performance was monitored daily by the quality control group at the plant, these measurements were supplemented by periodic monitoring of microbial loading and chemical oxidation demand (COD) from wash and rinse samples.

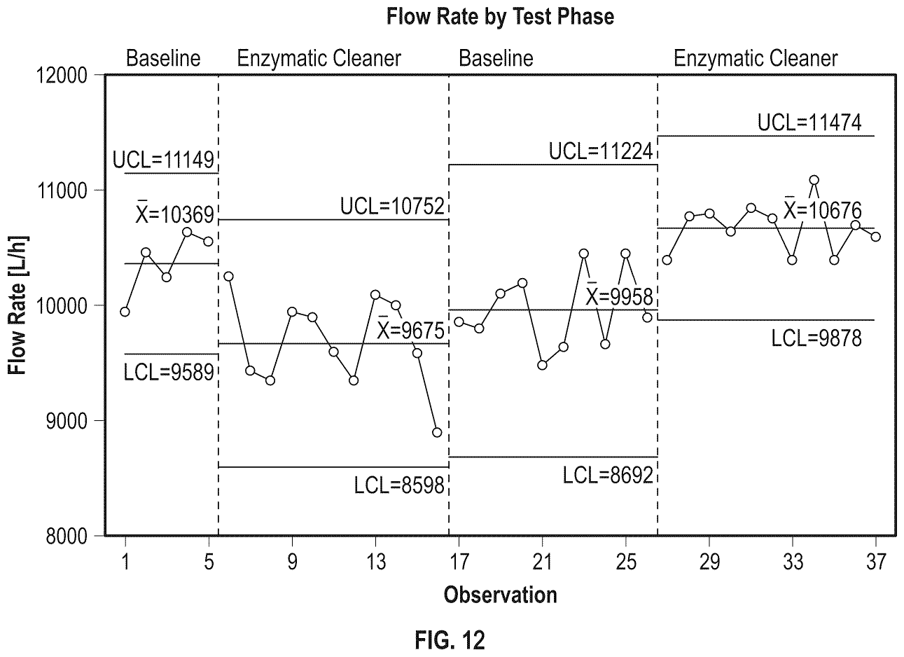

In the second phase of this field test, the long-term cleaning of the pasteurizer was of special interest to verify that no fouling (soil or scale build up) occurs over time. To monitor if fouling increases beyond normal levels due to cleaning with the enzymatic cleaner, the pasteurizer flow during production was tracked. The flow rate would be expected to decrease over the course of the trial if fouling occurred. Operators manually recorded the flow rate as well as the quantity and type of milk pasteurized. Comparable records were established during the baseline period of the trial to facilitate data comparison. This type of data was highly dependent on the operator, as the flow rate is influenced by how the valves are operated; however, this data can still give a rough indication on the performance of the cleaning product. FIG. 12 shows the flow rate of the pasteurizer recorded during the different trial phases.

These results as shown in FIG. 12 demonstrate that the blend of Formula D and Formula E were successful in cleaning the pasteurizer as the flow rate in the production was not significantly different compared to cleaning with the baseline product.

Field Test Cran for three months; two weeks where the performance of the baseline cleaner was monitored across the plant, two weeks where enzyme cleaner was run on the raw receiving CIP systems (milk and cream tankers, raw storage silos, premix tanks, and transfer lines), four weeks where enzyme cleaner was run on the cold-processing CIP systems (starter culture tanks, cream cheese culture silos, mixing tanks, transfer lines, and fillers), and four weeks where enzyme cleaner was run on the HTST pasteurizer. During the test, Formula D replaced the inline chlorinated alkaline cleaner on the raw receiving and cold-processing applications, whereas a mixture of Formula D and Formula E replaced the inline alkaline cleaner used on the pasteurizer.

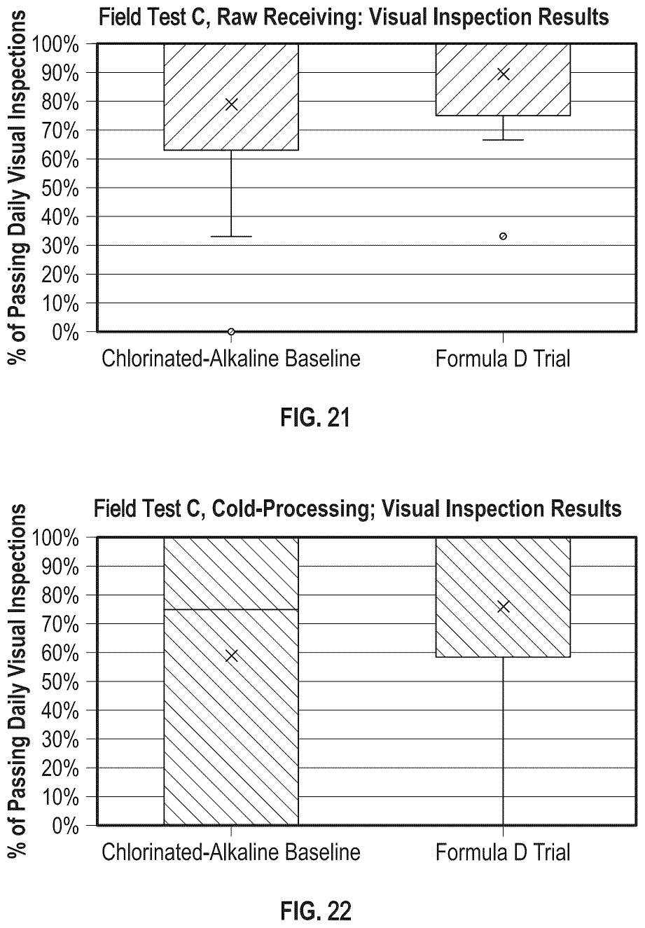

On the raw receiving CIP system, the general cleaning SOP was as follows: prerinse with fresh water, wash with chlorinated-alkaline cleaner, rinse with fresh water, apply sanitizer. The amount of chlorinated-alkaline product dosed in the baseline varied from 0.52 vol % to 1.02 vol %, depending on the equipment being cleaned; during the trial, this was replaced with 0.54 vol % to 0.76 vol % Formula D, depending on the equipment being cleaned. During the trial, the cleaning performance was determined via visual inspection of the cleaned surfaces. FIG. 21 demonstrates the baseline data compared with the trial data; demonstrating a slight increase in the percent of passing daily inspections during the trial period (baseline average 78.6%, trial average 89.2%, p=0.225, insignificant). These results suggest that the cleaning performance of Formula D was equivalent to or better than the inline chlorinated-alkaline product.

On the cold-processing CIP system, the general cleaning SOP was as follows: prerinse with reclaimed chlorinated-alkaline cleaner, wash with chlorinated-alkaline cleaner, rinse with fresh water, apply sanitizer. The amount of chlorinated-alkaline product dosed in the baseline was 1.02 vol %; during the trial, this was replaced with 0.76 vol % Formula D. During the trial, the cleaning performance was determined via visual inspection of the cleaned surfaces. FIG. 22 demonstrates the baseline data compared with the trial data; demonstrating a slight increase in the percent of passing daily inspections during the trial period (baseline average 58.2%, trial average 76.3%, −p=0.272, insignificant). These results suggest that the cleaning performance of Formula D was equivalent to or better than the inline chlorinated-alkaline product.

For the pasteurizer CIP, the general cleaning SOP was as follows: prerinse with fresh water, wash with acid cleaner, wash with alkaline cleaner, rinse with fresh water, apply sanitizer. A few SOP modifications were required to run Formula D and Formula E in place of the alkaline cleaner: a rinse was added between the acid and alkaline wash steps, and the wash temperature was reduced from 175° F. to 160° F. The amount of alkaline product dosed during the baseline was 2 vol %; during the trial, this was replaced with a mix of 0.4 vol % Formula D and 0.6 vol % Formula E.

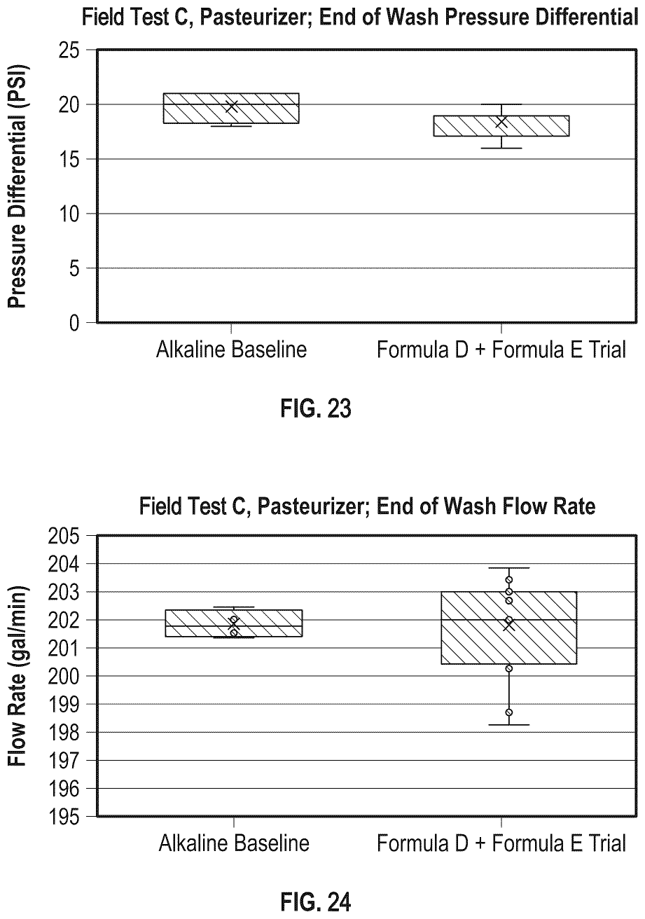

As pasteurizers are closed systems, it was not convenient to disassemble the unit to visually assay cleaning performance on a daily basis; instead, the cleaning performance during the baseline and trial periods was determined indirectly through the inlet/outlet pressure differential and the product flow rate. As the pump frequency is kept constant throughout the wash, the presence of soil in the pasteurizer would be expected to cause an increase in the pressure differential and a decrease in the flow rate. As FIG. 23 and FIG. 24 demonstrate, the baseline data and the trial data demonstrated similar flow rates and pressure differentials at the end of the wash. The average pressure differential as recorded at the end of the wash decreased during the trial period (baseline average 19.8 psi, trial average 18.4 psi, p=0.170, insignificant). The average flow rate as recorded at the end of the wash did not change relative to the baseline period (baseline average 201.8 gpm, trial average 201.9 gpm, p=0.967, insignificant). These results suggest that the performance of the cleaning solution formed by combining Formula D and Formula E was equivalent to or better than the inline alkaline product.

### Example 15

### CIP Cleaning Efficacy as Measured by COD.

Another method to detect possible fouling of the pasteurizer is measurement of COD. COD correlates to the concentration of organic matter in a sample, allowing the amount of soil in the cleaning solution to be accurately tracked throughout the CIP. COD was monitored on the last day of the baseline period and on the first day following the enzymatic Field Test B. Fouling of the pasteurized would be expected to result in higher COD measured after the trial than during the baseline period, resulting from additional soil in the pasteurizer which must have accumulated during the trial period of the enzymatic cleaner.

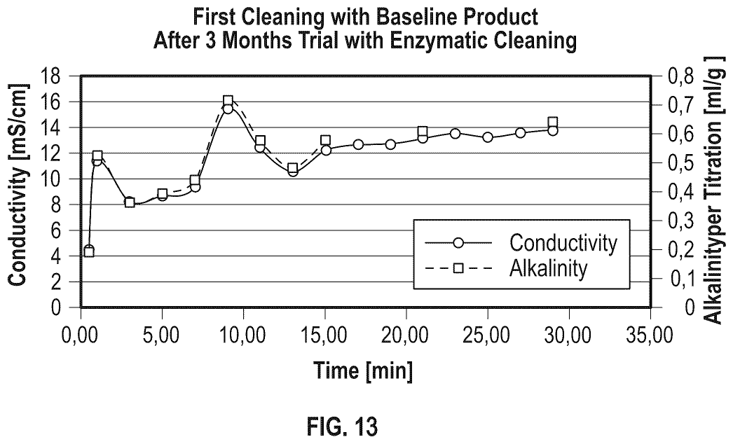

FIG. 13 shows the COD curve of the first cleaning with baseline cleaner after the long-term trial of the enzymatic cleaner. The variation in the COD matches with the observed variation in the alkalinity and conductivity of the sample indicating that the variations are likely due to imperfections in mixing during the wash step. Thus, as no notable increase in COD was seen, it can be concluded that there was no remaining soil in the system following the trial of the enzymatic cleaner, indicating that the blended cleaner was successful in cleaning during the long-term trial period.

### Example 16

### Formula Stability Performance.

As the activity of enzymes is inherently linked to their complex structure, the stabilization of enzymes in cleaning solutions is a critical step to ensuring constant and reliable cleaning performance. Dairy CIP is generally completed with alkaline cleaners, which have exemplary stability in concentrated form as well as in use-dilutions. Because of this, use-dilutions of alkaline cleaners are frequently stored re-used for several CIPs before being discarded. Although numerous enzymatic products exist with excellent stability in concentrated form, there is no existing enzymatic cleaning product which is designed for re-use in this manner. It is imperative that an enzymatic replacement for alkaline cleaners in a dairy environment must have exemplary stability in both the concentrate and use-dilutions.

A key component of the success of this product is the ability to withstand high temperatures. Dairy CIP systems typically function at or above 65° C. for days to weeks; conditions where the enzyme falls apart rapidly (under 1 hour) to a concentration of under 20% active enzyme. Thus, proving high temperature compatibility is paramount. Due to the frequency of washes in dairy CIP systems, the enzyme needs to not reach this level of degradation, with better enzyme stability being preferred in formulations.

Additional concentrate stability samples were prepared based on Formula B, which was found to have enhanced stability relative to Formula A. The enzyme stability was quantified for these samples after 4 weeks of storage at 50° C., a point at which the previous experiments demonstrated that Formula A would have an enzyme activity of less than 10%. The results of these stability experiments are given in Table 12.

TABLE 12

| | | monoeth- | trieth- | Remaining |
|---|---|---|---|---|
| | Glycerol | anolamine | anolamine | Enzyme |
| Formula | % active | % active | % active | Activity |
| Formula A | 10 | 4.95 | 0 | 6% |
| (control) | | | | |
| Formula B | 10 | 4.95 | 0 | 15% |
| Formula B-1 | 10 | 2.48 | 2.48 | 27% |
| Formula B-2 | 20 | 2.48 | 2.48 | 46% |
| Formula B-3 | 30 | 2.48 | 2.48 | 71% |
| Formula B-4 | 40 | 2.48 | 2.48 | 79% |

The results of Table 12 demonstrate that stability for Formula B can be dramatically improved by either by increasing the amount of glycerol in the formula or by supplementing the buffer with triethanolamine in place of the monoethanolamine.

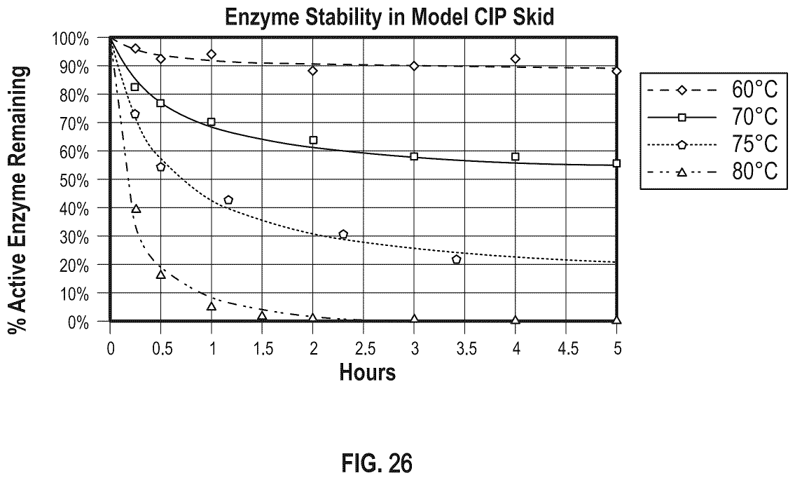

A model re-use CIP skid was used to test the use-dilution stability of Formula A. In this experiment a use-dilution of 0.5% Formula A was created in the balance tank and then was circulated through a shell and tube heat exchanger to bring the solution to a constant temperature. The holding temperature was maintained for five hours and samples were collected routinely to assay the enzyme activity. The results of this experiment are shown in FIG. 26.

These results demonstrate that a use-dilution of Formula A is quite stable at lower temperatures, but degrades much more rapidly as the holding temperature increases. As dairy re-use CIP solutions are usually kept between 55° C. and 65° C., Formula A should be suitable for use in these solutions. Furthermore, as reclaimed wash solutions are generally topped off with a fresh dose of cleaner before each wash, the enzyme activity should remain nominal even at temperatures up to 70° C.

To verify the results from the model CIP skid, the enzyme activity was closely tracked in Field Tests A and C of Example 11 which employed re-use CIP systems. The raw receiving CIP system used in Field Test A included three tanks: a wash tank, a rinse tank, and a sanitizer tank. Throughout the wash step, the conductivity of the reclaimed wash solution was monitored and additional cleaner was automatically dosed when the conductivity fell below a set threshold. After the wash step, a majority of the cleaning solution was pumped back into the wash tank. Following the wash step, a fresh water rinse was conducted; the first few seconds of this rinse, consisting of fresh water mixed with residual cleaner solution, was reclaimed into the rinse tank. This reclaimed rinse solution is used for the pre-rinse for the next CIP. The sanitizer tank holds only fresh water and freshly-prepared sanitizer solution.

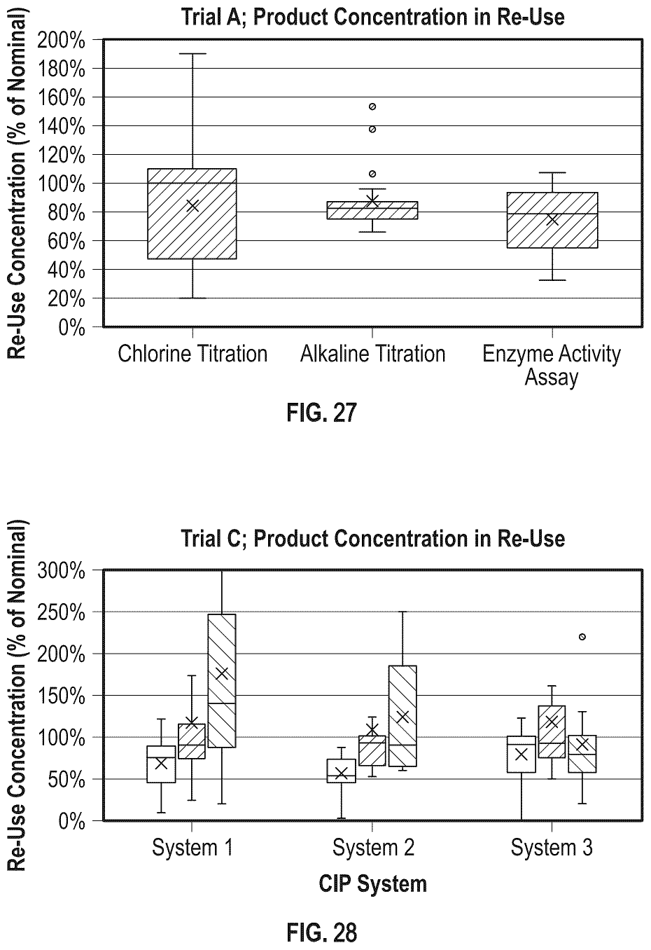

During the baseline period of Field Test A, the concentration of the alkaline cleaner and hypochlorite in the re-use system were tracked via two titrimetric methods: one being a pH titration and the other being an oxidizer titration. During the trial period, the concentration of active enzyme in the re-use system was tracked using enzyme activity assays. FIG. 27 shows the concentration of cleaner in the re-use system tracked throughout Field Test A, with the values normalized to the percent of time that the concentration were 1500 ppm active alkaline as NaOH, 50 ppm active hypochlorite, and enzyme activity equivalent to 0.5% Formula C.

As FIG. 27 demonstrates, the observed variability was highest with hypochlorite, then with enzyme, and finally with alkalinity. This trend correlates well with the known stability of these compounds; hypochlorite being an unstable oxidizer, alkalinity being quite stable, and enzymes being somewhat stable. Overall, the amount of time each active was found to be within +20% of the concentration called for in the CIP SOP was 40.0% for the hypochlorite, 48.3% for the enzyme, and 54.2% for the alkaline. This demonstrates that the enzyme cleaner is approximately as comparable with the re-use CIP system as the baseline chemistry, indicating it could be a suitable replacement.

Field Test C also included several re-use CIP systems. The raw receiving CIP used in Field Test C consisted of two separate CIP systems, 1 and 2. System 1 was composed of one wash tank and one rinse/sanitizer tank. Throughout the wash step, the conductivity of the wash solution was monitored and additional cleaner was automatically dosed when the conductivity fell below a set threshold. After the wash step, a majority of the cleaning solution was pumped back into the wash tank for re-use. The rinse/sanitizer tank is used to hold fresh water for rinsing and for making up sanitizer solution. System 2 was composed of one wash tank, one rinse tank, and one sanitizer tank and functions identically to the system described in Field Test A. The cold-processing CIP system also contained a re-use CIP system, System 3, composed of one wash tank and one rinse/sanitizer tank which functions identically to System 1.

During the baseline and trial periods, the active cleaning chemical concentration was monitored using the same methods as in Field Test A. FIG. 28 show the concentrations of cleaner tracked throughout Field Test C.

On System 1, the amount of time the cleaning products were found to be within +20% of nominal was 20.0% for hypochlorite, 46.9% for alkaline, and 31.0% for enzyme. On system 2 this was 15.4% for hypochlorite, 50.0% for alkaline, and 23.1% for enzyme. On system 3 this was 58.8% for hypochlorite, 38.9% for alkaline, and 46.2% for enzyme. Notably, the hypochlorite concentration was found to almost always be low, likely resulting from the inherent instability of hypochlorite at high temperatures and in the presence of soils. In contrast, the concentration of enzyme was often found to be higher than anticipated, suggesting that the system was more prone to overshooting the target concentration with the enzyme-based cleaner. As the enzyme was generally found to be at or above the concentration required for cleaning more often than the hypochlorite, it should be found to be a suitable replacement.

### Example 17

Compatibility with Existing Equipment. Foam Height Testing.

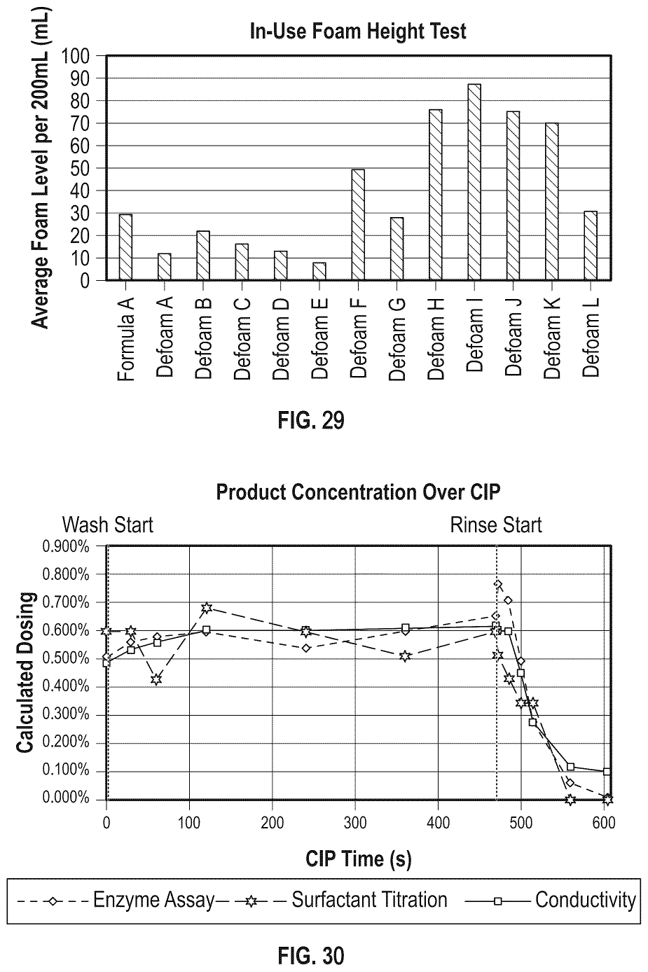

The equipment used to clean dairy facilities represents a significant financial investment to the company which purchases it, as such it is desirable that a new cleaner for dairy equipment should be compatible with the existing cleaning equipment. Generally, high flow rates are used during CIP to create turbulent flow, the shear stress of which is able to enhance the efficacy of the CIP. Due to the high shear stress experienced by the cleaning solution, the formation of foam in CIP systems is often of concern. Because of this, CIP cleaners which are low foaming are highly preferred. As the level of foam formation is generally dictated by the surfactants in the formula, several blends of surfactant were screened for their ability to form foam using an In-Use Foam Height Test in which 200 mL of 0.5% use-solution at 60° C. was shaken in a 250 mL graduated cylinder, the volume of foam formed being read by the graduations The formulas were created using Formula B as a base, but with varied surfactant compositions. The results of the test are shown in FIG. 29 and the formulas are as shown in Table 13.

TABLE 13

| Blend | Emulsifying | Defoaming | Defoaming |
|---|---|---|---|
| Name | Surfactant A | Surfactant B | Surfactant C |
| Formula | 4% C8-10 | 5.5% EO PO EO | — |
| A | Polyglucoside, | Block Copolymer, | |
| | DP 1.7 | MW 2000, 10% EO | |
| Defoam A | 4% C8-10 | 5.5% EO PO EO | 1% C13-15 Linear |
| | Polyglucoside, | Block Copolymer, | and Branched |
| | DP 1.7 | MW 2450, 20% EO | Alcohol, 5.4 PO 2.1 |
| | | | EO and 5.4 PO |
| | | | Blends |
| Defoam B | 4% C8-10 | 5.5% EO PO EO | 1% C12-15 Linear |
| | Polyglucoside, | Block Copolymer, | Alcohol, 7 EO |
| | DP 1.7 | MW 2450, 20% EO | |
| Defoam C | 4% C8-10 | 5.5% EO PO EO | 1% C13-15 Linear |
| | Polyglucoside, | Block Copolymer, | & Branched, 9.6 |
| | DP 1.7 | MW 2450, 20% EO | EO, 1.5 BO, |
| | | | Butyl Capped, |
| | | | 95% |
| Defoam D | 4% C8-10 | 5.5% EO PO EO | 1% C12-14 Linear |
| | Polyglucoside, | Block Copolymer, | Alcohol, 5 EO, 4 PO |
| | DP 1.7 | MW 2450, 20% EO | |
| Defoam E | 4% C8-10 | 5.5% EO PO EO | 1% C12-14 Linear |
| | Polyglucoside, | Block Copolymer, | Alcohol, 2 EO, 4 PO |
| | DP 1.7 | MW 2450, 20% EO | |
| Defoam F | 4% C8-10 | 1% C13-15 Linear | — |
| | Polyglucoside, | and Branched | |
| | DP 1.7 | Alcohol, 5.4 PO 2.1 | |
| | | EO and 5.4 PO | |
| | | Blends | |
| Defoam G | 1% C10-16 | 2% PO | — |
| | Polyglucoside, | homopolymer MW | |
| | DP 1.3 | 2000 | |
| Defoam H | 1% C10-16 | 2% EO PO EO | — |
| | Polyglucoside, | Block Copolymer, | |
| | DP 1.4 | MW 2000, 10% EO | |
| Defoam I | 1% C10-16 | 2% EO PO EO | — |
| | Polyglucoside, | Block Copolymer, | |
| | DP 1.4 | MW 2500, 20% EO | |
| Defoam J | 1% C10-16 | 2% PO EO PO | — |
| | Polyglucoside, | Block Copolymer, | |
| | DP 1.4 | MW 4500, 30% EO | |
| Defoam K | 1% C10-16 | 2% C12-14 Linear | — |
| | Polyglucoside, | Alcohol, 5 EO, 4 | |
| | DP 1.4 | PO | |
| Defoam L | 1% C10-16 | 2% C12-14 Linear | — |
| | Polyglucoside, | Alcohol, 2 EO, 4 | |
| | DP 1.4 | PO | |

This experiment demonstrated that higher molecular weight APGs tend to foam more than their lower molecular weight counterparts. Additionally, EO-PO, alkoxylated alcohols, and blends thereof were found to be beneficial defoamers for the APGs.

As the enzymatic detergents formulas disclosed herein contain a pH buffer, they have some amount of electrical conductivity; however, the level of electrical conductivity at use-dilution is significantly below 1,000 μS/cm, making it challenging to distinguish from the conductivity of the supply water in several cases. To enhance the conductivity of these formulas in their use-dilution, salts were added. These salts could either be directly added, as in the case of Formula B, they could be produced as a result of a reaction, or both as in Formulas C and D. Several salts were screened for inclusion in the formulations; however, blends of salts with lower molecular weight were found to be most preferred. This is the case for two reasons: lower molecular weight salts produce more ions per weight percent in the formula increasing the conductivity significantly more than higher molecular weight salts, and blends being preferred over single salts as the solubility of single salts is limited by the common ion effect. Other limitations on the selection of salts may be made based on regional restrictions on dairy wastewater effluent; for example, in the USA the emission of nitrates and phosphates are regulated in several regions, leading them to be less preferred for use in dairy cleaning formulations. Table 14 demonstrates several variations of Formula B which were prepared with varying amounts of salt, the amount of coupler needed to stabilize the formulas, and the conductivity increase of a 0.5% use-dilution above baseline hard water.

TABLE 14

| | | | | | | In-use |
|---|---|---|---|---|---|---|
| Base | | % active | | % active | % active | Conductivity |
| Formula | Salt 1 | Salt 1 | Salt 2 | Salt 2 | coupler | (uS/cm) |
| Formula A | — | — | — | — | 1.2 | 571 |
| Formula A | NaCl | 3.5 | — | — | 1.2 | 865 |
| Formula B | NaCl | 7.3 | — | — | 5.2 | 1083 |
| Formula B | KCl | 7.4 | — | — | 2 | 989 |
| Formula B | Na₂SO₄ | 5.8 | NaCl | 3.5 | 3.2 | 1032 |
| Formula B | NaC₂H₃O₂ | 6.3 | NaCl | 3.5 | 2.4 | 948 |

The use of sodium acetate and sodium chloride in Formula B allows for a high conductivity use-solution while requiring approximately half of the coupler of a pure sodium chloride salt addition. Formulas C and D contain the same mixture of sodium chloride and sodium acetate as a conductivity booster; however, in these formulas the reaction used to form the buffer also forms the sodium acetate in-situ through the neutralization of acetic acid. Although the level of conductivity in all of these formulations was notably less than that of an alkaline cleaner, it was hypothesized that this level of conductivity should be sufficiently conductive to control the chemical concentration in CIP.

During trials of Example 11, the ability of the CIP system to maintain the chemical concentration above a set threshold throughout the wash step was monitored to ensure that the conductivity of the enzymatic formulas was sufficient to control their use in the same manner as alkaline cleaners.

In Field Test A the ideal dosing of Formula C was determined to be 0.5 vol %. This corresponded to a conductivity setpoint of 750 μS/cm above the baseline water, as measured by the plant's inline conductivity probes. This setpoint was programmed into the CIP system and the product dosing was controlled via the automated dosing system for the duration of the trial. After this setpoint was implemented, the product dosing was monitored through every wash, with the cleaner concentration being determined manually by titrating the amount of surfactant in the CIP system. It was found that the chemical dosing remained consistent throughout the remainder of the trial period (average 0.55 vol %, standard deviation 0.07 vol %, minimum recorded 0.43 vol %, maximum recorded 0.68 vol %). For one wash, the chemical concentration was monitored throughout the wash and rinse steps through three different methods: electrical conductivity, surfactant titration, and enzyme activity assays. The results of these methods are shown in FIG. 30. Notably, all of the methods show a reasonable degree of agreement, indicating that the conductivity of the solution is a sufficient analog to use for determining the concentration of the cleaner in a CIP system. This data demonstrates the compatibility of the enzymatic cleaner with the existing CIP dosing control system.

In Field Test B the re-use CIP system (used to CIP all system except for the pasteurizer) was controlled by conductivity. During the second phase of this trial, the product dosing was solely controlled by conductivity: with a target concentration of 0.5 vol % controlled by conductivity limits of 1.2-1.4 mS/cm. During the long-term trial period, the dosing was well controlled: average dosing 1.3 mS/cm (0.50 vol %), minimum 1.0 mS/cm (0.38 vol %), maximum 1.8 mS/cm (0.69 vol %). Additionally, during the trial the phase separation was controlled by conductivity. A lower conductivity limit was set at 1.0 mS/cm for recovery of the cleaning solution to the re-use tank. Noting the baseline water conductivity of the plant is 0.3 mS/cm and the dosing setpoint is 1.3 mS/cm, this correlates to a minimum recovery concentration of approximately 0.35 vol %. This worked well during the trial, allowing for the re-use wash solution to be reclaimed until the conductivity dropped from the rinse phase.

In Field test C the re-use CIP systems 1, 2, and 3 all controlled the dosing of the cleaner using a conductivity-based automated dosing system. Concentrations of cleaner were manually tested throughout the baseline by titrating the concentration of alkaline and in the trial using an enzyme activity assay. From this data, the amount of time that the cleaner was at 10% below the nominal dosing or above was determined for each system. In System 1 alkaline was found to be in this range 59.4% of the time, and enzyme 75.9% of the time. For System 2 alkaline was found to be in this range 50.0% of the time, and enzyme was found to be 61.5% of the time. For System 3 alkaline was found to be in this range 50.0% of the time and enzyme 42.3% of the time. From this data, it appears that the fraction of times the dosing is near or above nominal for the enzyme cleaner are similar to those of alkaline cleaner, indicating that the reliability of conductivity based dosing is similar to that of the baseline despite the lower conductivity of the enzymatic cleaner.

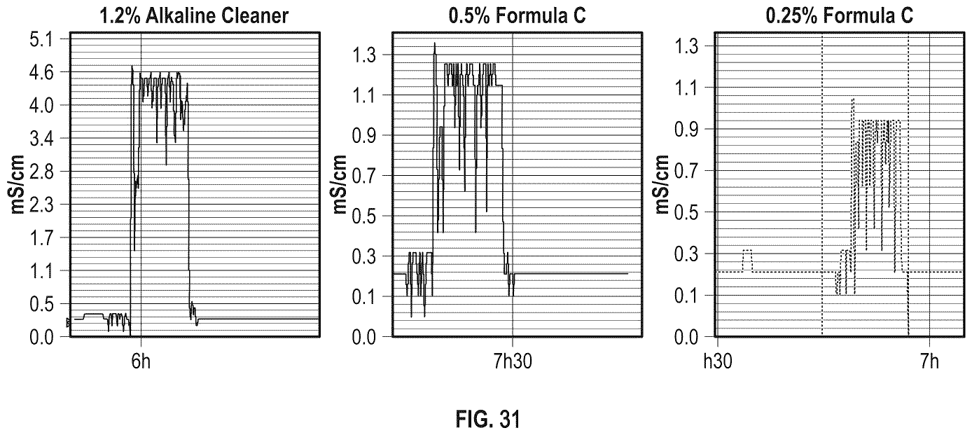

One additional trial, Field Test D, was run at a small cheese producer and focused specifically on controlling the phase separation in the post-wash rinse step of a re-use CIP system via its conductivity. A 10 wash baseline was conducted using the inline alkaline cleaner (dosed at 1.2 vol %), then two washes were conducted with 0.5% Formula C and two more were conducted with 0.25% Formula C. The conductivity read by the CIP control unit is shown for one wash step in each phase of Field Test D in FIG. 31.

The total measured conductivity during the wash step was 4.5 mS/cm during the baseline and decreased to 1.3 mS/cm and 0.9 mS/cm during the subsequent Formula C trials. The conductivity baseline of the plant's water measured at approximately 0.25 mS/cm. In all cases, the control unit was able to detect the end of the wash phase and successfully diverted the flow from the reclaim tank to the drain as the wash solution's conductivity dropped during the rinse step. This data demonstrates the compatibility of the enzymatic formula with the existing CIP infrastructure used for phase separation.

The disclosures being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure, the invention resides in the claims.

What is claimed is:

1. A method of cleaning a dairy processing system comprising:
circulating a first dose of a cleaning composition to the dairy CIP system; wherein the cleaning composition comprises a serine protease enzyme; a surfactant comprising an alkylpolyglucoside, an EO-PO block copolymer, an alcohol alkoxylate, and/or mixtures thereof; a water conditioning agent comprising an aminocarboxylic acid, acrylic acid, polycarboxylic acids, salts of the foregoing, and/or mixtures thereof; a C2-C10 polyol; a buffer system; and water; wherein the pH of the cleaning composition is between about 6 and about 11;
monitoring the cleaning composition during the cleaning of the dairy processing system;
adjusting the concentration of the cleaning composition by adding additional water and/or an additional dose of the cleaning composition to the dairy processing system.

2. The method of claim 1, wherein monitoring the cleaning composition comprises monitoring the conductivity of the cleaning composition.

3. The method of claim 2, wherein the conductivity is monitored by measuring the conductivity of at least one salt of the cleaning composition.

4. The method of claim 3, wherein the conductivity of the salt of the cleaning composition is below 5000 μS/cm.

5. The method of claim 3, wherein the conductivity of the salt of the cleaning composition is below 1000 μS/cm.

6. The method of claim 1, wherein the monitoring the cleaning composition comprises monitoring the pH of the cleaning composition.

7. The method of claim 1, wherein the cleaning composition further comprises at least one coupling agent.

8. The method of claim 1, wherein the method is performed at a temperature of from about 40° C. to about 95° C.

9. The method of claim 1, wherein the cleaning composition is circulated through the system for 90 minutes or less.

10. The method of claim 1, wherein the cleaning composition is provided in a multi-part system.

11. A caustic free liquid cleaning composition for dairy processing systems and components thereof comprising:
a serine protease enzyme;
from about 0.5 to about 20% actives of a surfactant comprising an alkylpolyglucoside, an EO-PO block copolymer, an alcohol alkoxylate, and/or a mixture thereof;
from about 0.1 to about 10% actives of a water conditioning agent; wherein the water conditioning agent comprises an aminocarboxylic acid, acrylic acid, polyacrylic acid, and/or a mixture thereof;
a C2-C10 polyol;
a buffer system comprising an acid and/or a base; and
water; wherein the composition has a pH of from about 6 to about 11.

12. The composition of claim 11, further comprising from about 2 to about 15% actives of a salt; wherein the salt is for conductivity monitoring of the liquid cleaning composition and comprises an anion selected from the group consisting of a carboxylate, a chloride, a sulfate, and mixtures thereof; and wherein the salt comprises a cation selected from the group consisting of magnesium, sodium, potassium, and mixtures thereof.

13. The composition of claim 12, wherein the salt is from about 5 to about 12% actives.

14. The composition claim 11, further comprising from about 0.1 to about 10% actives of at least one coupling agent.

15. The composition of claim 14, wherein the at least one coupling agent comprises one or more of the following sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and sodium butylnaphthalene.

16. The composition of claim 11, wherein the buffer system comprises an ethanolamine and/or a C1-C10 carboxylic acid.

17. The composition of claim 11, wherein the cleaning composition further comprises an additional surfactant.

18. The composition of claim 11, wherein the cleaning composition further comprises a pH adjuster.

19. The composition of claim 11, wherein the surfactant comprises a mixture of at least two of an alkylpolyglucoside, an EO-PO block copolymer, and an alcohol alkoxylate.

20. The method of claim 11, wherein the surfactant comprises each of an alkylpolyglucoside, an EO-PO block copolymer, and an alcohol alkoxylate.
